(19) United States
(12) Patent Application Publication
(10) Pub. No.: US 2026/0127397 A1
(43) Pub. Date: May 7, 2026

(54) BIOLOGICALLY INSPIRED ACTIVE VISUAL COMMUNICATION SYSTEM AND METHOD

(71) Applicant: Georgia Tech Research Corporation, Atlanta, GA (US)

(72) Inventors: Bert BRAS, Atlanta, GA (US); Marc WEISSBURG, Atlanta, GA (US); Bryan COCHRAN, Atlanta, GA (US); Hanlong LI, Atlanta, GA (US); Bryan STARBUCK, Atlanta, GA (US)

(21) Appl. No.: 19/377,604

(22) Filed: Nov. 3, 2025

Related U.S. Application Data
(60) Provisional application No. 63/715,082, filed on Nov. 1, 2024.

(51) Int. Cl. G06K 7/14; H04N 7/22

(52) U.S. Cl. CPC G06K 7/1417; H04N 7/22

(57) ABSTRACT

An exemplary system and method are disclosed for providing visual communication between agents in a multi-agent system. In some implementations, the exemplary system and method are configured to (i) receive and decode a data packet or message visually received from other communication targets and (ii) visually transmit a reply data packet or message, in response to the communication targets, using a digital or electromechanical display.

### RELATED APPLICATION

This application claims priority to, and the benefit of, U.S. Provisional Patent Application No. 63/715,082, filed Nov. 1, 2024, entitled “BIOLOGICALLY INSPIRED ACTIVE VISUAL COMMUNICATION SYSTEM,” which is incorporated by reference herein in its entirety.

### BACKGROUND

Communication systems rely on analog or digital modalities to transmit information between entities. Analog communication conveys signals in a continuous form, while digital communication encodes information into discrete packets transmitted across structured networks.

In digital communication, a data packet is a predefined unit of data that includes both payload and control information, facilitating reliable and efficient transmission. Packet-based communication is foundational to modem networking, facilitating distributed systems to coordinate actions, share data, and respond to dynamic environments.

Multi-agent systems (e.g., fleets of autonomous robots or distributed platforms) operate in environments where current communication channels (e.g., radio frequency, audio) may be unreliable, bandwidth-limited, or subject to interference, hindering exchanges of data packets or messages between the agents. Therefore, an alternative modality for inter-agent communication is desirable.

There is a benefit to developing a communication system and method that can function in constrained or degraded environments to provide coordination and interaction among autonomous agents.

### SUMMARY

An exemplary system and method are disclosed for providing visual communication between agents in a multi-agent system. In some implementations, the exemplary system and method are configured to (i) receive and decode a data packet or message visually received from other communication targets and (ii) visually transmit a reply data packet or message, in response to the communication targets, using a digital or electromechanical display.

Inspired by biological examples of non-verbal communication (e.g., signaling behaviors of honeybees, primates, and other animals), the exemplary system and method encode information into visually perceptible formats (e.g., a fiducial marker on a display) that can be interpreted among agents in a multi-agent system. The exemplary system and method facilitate agents to (i) visually receive and decode a data packet or message from one another, and (ii) visually transmit, to one another, a reply data packet or message using a digital or electromechanical display.

By adopting visual communication, the exemplary system and method improve the robustness and adaptability of inter-agent communication, particularly in environments where current communication channels (e.g., radio frequency, audio) are unreliable or unavailable. This represents an improvement in computer and communication technology by introducing a visual communication that enhances coordination and interaction in distributed autonomous systems.

The exemplary system and method can be employed for communication between agents in a multi-agent system, including but not limited to (i) unmanned aerial vehicles (UAVs) (e.g., drones, quadcopters, etc.), (ii) autonomous ground vehicles (e.g., autonomous tractors, autonomous haulage vehicles, etc.), (iii) unmanned sea vehicles (USVs) (e.g., saildrones, autonomous submarines, etc.), (iv) autonomous or teleoperated robots, and (v) manned communication operation (e.g., personnel equipped with transceivers or user interfaces). The exemplary system is operable in environments where current communication methods (e.g., radio, audio) are not feasible, and can interface with either software-based agents or human-operated devices to encode and decode visual messages for bidirectional communication.

In an aspect, a receiver is disclosed comprising: a camera configured to acquire an image of a scene; and a receiver controller comprising: a receiver processor; and a receiver memory having receiver instructions stored thereon, wherein execution of the receiver instructions causes the receiver processor to: receive an image of the scene; determine presence of a first fiducial marker in the received image, wherein the first fiducial marker has an encoded data packet, transmitted optically via a transmitter, having a message; and determine, via a trained artificial intelligence (AI) model (e.g., CNN), one or more observable marker elements of the first fiducial marker, wherein the one or more observable marker elements are used to determine a packet structure for a reply message or a decoding of the first fiducial marker.

In some embodiments, the trained AI model was trained to detect and classify observable marker elements using a set of fiducial markers (e.g., QR code, etc.) acquired from a set of images or a training dataset, wherein the AI model was trained using fiducial markers and an associated number of observable marker elements as the training data.

In some embodiments, the packet structure is configured to be used in a packet transmitted to a target, wherein the packet structure includes an indicator that the target does not need to respond (e.g., zero-level complexity), wherein the packet structure is mapped to an arrangement of the one or more observable marker elements.

In some embodiments, the packet structure is configured to be used in a packet transmitted to a target, wherein the packet structure includes an indicator that the target generates a one-time response (e.g., confirmation, ACK) (e.g., low-level complexity), wherein the packet structure is mapped to an arrangement of the one or more observable marker elements.

In some embodiments, the packet structure is configured to be used in a packet transmitted to a target, wherein the packet structure includes an indicator that the target initiates a subsequent serial exchange of messages with the receiver (e.g., high-level complexity), wherein the packet structure is mapped to an arrangement of the one or more observable marker elements.

In some embodiments, the first fiducial marker is generated or decoded according to a protocol defined by an adjustable AprilTag.

In some embodiments, the first fiducial marker is generated or decoded according to an adjustable protocol selected from or based on the group consisting of a QR code, a Ju marker, a Chroma tag, a Vu mark, a Topo tag, an S tag, and an ArUco tag.

In some embodiments, the one or more observable marker elements are subsequently used by a transmitter, the transmitter comprising: a transmitter controller comprising: a transmitter processor; and a transmitter memory having transmitter instructions stored thereon, wherein execution of the transmitter instructions causes the transmitter processor to: receive the one or more observable marker elements of the first fiducial marker; determine a packet structure of the encoded data packet using the one or more observable marker elements of the first fiducial marker, wherein the determined packet structure is mapped to the one or more observable marker elements of the first fiducial marker; determine a second fiducial marker having a second encoded data packet, wherein the second encoded data packet has same packet structure as the determined packet structure and includes the reply message; and demonstrate the second fiducial marker on a display, wherein the second fiducial marker is subsequently imaged for extracting the second encoded data packet.

In some embodiments, the display is an electromechanical display comprising: a plurality of tiles (e.g., flappers, placards), each being configured to show an observable marker element of the second fiducial marker; and one or more actuators operatively coupled to the plurality of tiles, the one or more actuators being configured to flip the plurality of tiles in accordance with an arrangement of the one or more observable marker elements of the second fiducial marker.

In some embodiments, each tile is a flapper or a printed placard.

In some embodiments, the display is a digital display (e.g., computer monitor, phone screen) having a plurality of pixels, each pixel being configured to show an observable marker element of the second fiducial marker.

In an aspect, a transmitter is disclosed comprising: a transmitter controller comprising: a transmitter processor; and a transmitter memory having transmitter instructions stored thereon, wherein execution of the transmitter instructions causes the transmitter processor to: receive one or more observable marker elements of a first fiducial marker from an external device or from a camera, wherein the first fiducial marker has an encoded data packet having a message; determine a packet structure of the encoded data packet using the one or more observable marker elements of the first fiducial marker, wherein the determined packet structure is mapped to the one or more observable marker elements of the first fiducial marker; determine a second fiducial marker having a second encoded data packet, wherein the second encoded data packet has same packet structure as the determined packet structure and includes a reply message; and demonstrate the second fiducial marker on a display, wherein the second fiducial marker is subsequently imaged for extracting the second encoded data packet.

In some embodiments, the display is an electromechanical display comprising: a plurality of tiles (e.g., flappers, placards), each being configured to show an observable marker element of the second fiducial marker; and one or more actuators operatively coupled to the plurality of tiles, the one or more actuators being configured to flip the plurality of tiles in accordance with an arrangement of the one or more observable marker elements of the second fiducial marker.

In some embodiments, each tile is a flapper or a printed placard.

In some embodiments, the display is a digital display (e.g., computer monitor, phone screen) having a plurality of pixels, each pixel being configured to show an observable marker element of the second fiducial marker.

In yet another aspect, a non-transitory computer-readable medium having instructions stored thereon is disclosed, wherein execution of the instructions causes a receiver processor to: receive an image of a scene acquired by a camera; determine presence of a first fiducial marker in the received image, wherein the first fiducial marker has an encoded data packet, transmitted optically via a transmitter, having a message; and determine, via a trained artificial intelligence (AI) model (e.g., CNN), one or more observable marker elements of the first fiducial marker, wherein the one or more observable marker elements are used to determine a packet structure for a reply message or a decoding of the first fiducial marker.

In some embodiments, the trained AI model was trained to detect and classify observable marker elements using a set of fiducial markers (e.g., QR code, etc.) acquired from a set of images or a training dataset, wherein the AI model was trained using fiducial markers and an associated number of observable marker elements as the training data.

In some embodiments, the first fiducial marker is generated or decoded according to a protocol defined by an adjustable AprilTag.

In some embodiments, the execution of the instructions further causes a transmitter processor to: receive the one or more observable marker elements of the first fiducial marker; determine a packet structure of the encoded data packet using the one or more observable marker elements of the first fiducial marker, wherein the determined packet structure is mapped to the one or more observable marker elements of the first fiducial marker; determine a second fiducial marker having a second encoded data packet, wherein the second encoded data packet has same packet structure as the determined packet structure and includes the reply message; and demonstrate the second fiducial marker on a display, wherein the second fiducial marker is subsequently imaged for extracting the second encoded data packet

In some embodiments, the display is an electromechanical display including: a plurality of tiles (e.g., flappers, placards), each being configured to show an observable marker element of the second fiducial marker; and one or more actuators operatively coupled to the plurality of tiles, the one or more actuators being configured to flip the plurality of tiles in accordance with an arrangement of the one or more observable marker elements of the second fiducial marker.

### BRIEF DESCRIPTION OF DRAWINGS

FIGS. 1A-1B each shows an example visual communication system for exchanging information (e.g., data packets, messages), via visual communication, between transmitters and receivers, or between transceivers, in accordance with an illustrative embodiment.

FIGS. 2A-2B show example types of packet-structure-based visual communication, in accordance with an illustrative embodiment.

FIG. 3A shows an example method of operating a receiver of the exemplary system, in accordance with an illustrative embodiment.

FIG. 3B shows an example method of operating a transmitter of the exemplary system, in accordance with an illustrative embodiment.

FIGS. 4A-4B show example communication flows between (i) a transmitter and a receiver, and (ii) two transceivers, respectively, in accordance with an illustrative embodiment.

FIG. 5A shows example AprilTag fiducial markers from various AprilTag families.

FIG. 5B shows example display states that are broadcast using non-AprilTags.

FIG. 6A shows an example actuator-flapper assembly, where a rotational actuator is mechanically coupled to a flapper using mated spur gears.

FIG. 6B shows an example pixel base to support an actuator-flapper assembly.

FIG. 6C shows a front view of an electromechanical display.

FIG. 6D shows an example electromechanical display with an integrated camera mount.

FIG. 6E shows an example integration of a display array in the electromechanical display with a display mount and cross-members.

FIG. 6F shows an example turntable for the electromechanical display.

FIG. 6G shows an example mounting interface to an external platform (e.g., Crover) coupled to the bottom plate of the turntable.

FIG. 6H shows an example ring gear configured as a rotation mechanism for the display mount.

FIG. 6I shows an example electromechanical display system employing a rotation mechanism and a counterweight arm.

FIG. 6J shows an example T-rail end cap configured to fix and center the ring gear of the rotation mechanism.

FIG. 6K shows a front view of a complete electromechanical display system.

FIG. 7A shows an example electrical configuration for the transceiver of the exemplary system.

FIG. 7B shows an example control configuration of the transceiver of the exemplary system.

FIG. 8A shows a box-and-whisker plot comparing the performance of the detection algorithm, implemented in a trained AI model of an experimental system described in FIGS. 1-4, with and without a cyclic redundancy check (CRC).

FIG. 8B shows an autonomous vehicle, referred to as Crover, coupled to the experimental system in an evaluation of the experimental system.

FIG. 8C shows the layout for the passive signage test in the evaluation of the experimental system.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

As used herein, the term “packet structure” refers to a structure of a data packet, or a structure of a message therein, that includes information intended for transmission to a communication entity or exchange between multiple communication entities. The packet structure may be formatted according to predefined structural rules (see Equations 1-3) to support reliable delivery, interpretation, and processing within the exemplary system.

### Example System

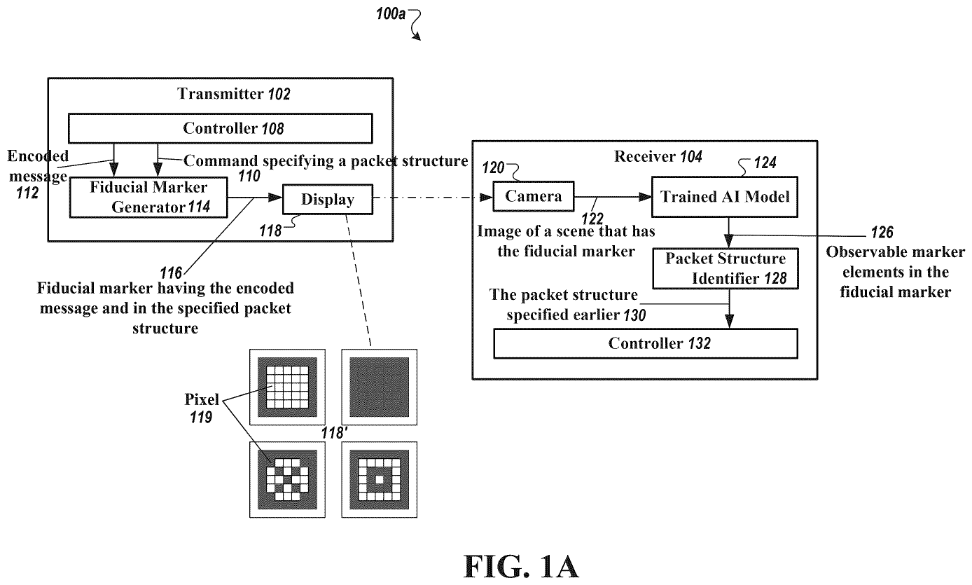

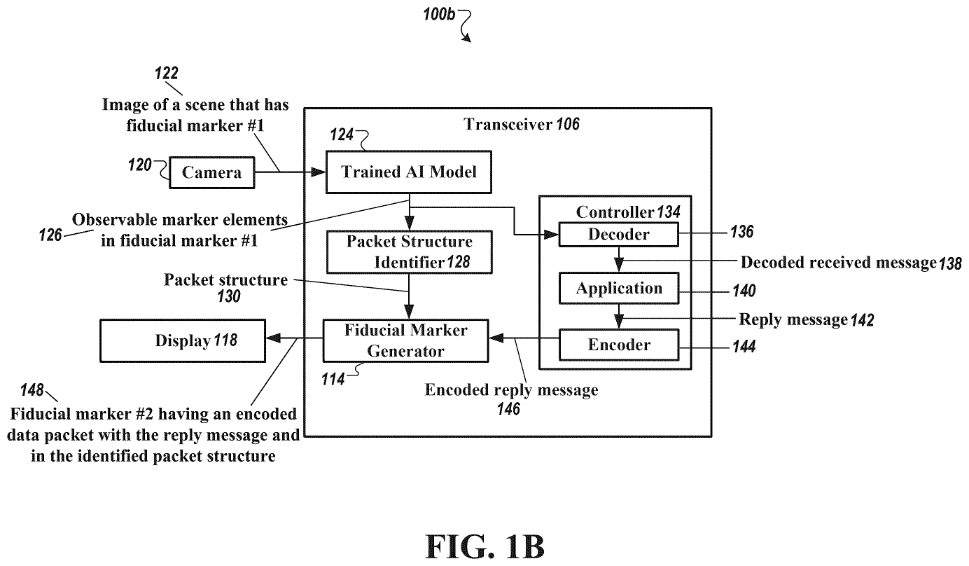

FIGS. 1A-1B each shows an example visual communication system 100 (shown as 100a and 100b) for exchanging information (e.g., data packets, messages) via visual communication between transmitters and receivers, or between transceivers. In FIG. 1A, the exemplary system 100a employs a transmitter 102 and a receiver 104, each configured to visually communicate with the other. In FIG. 1B, the exemplary system 100b employs a transceiver 106 configured to perform the operations of both transmitter 102 and receiver 104.

Transmitter (102). In the example shown in FIG. 1A, the transmitter 102 includes a controller 108, a fiducial marker generator 114, and a display 118. The controller 108 is configured to send, to the fiducial marker generator 114, (i) a command 110 (e.g., digital signal) specifying a packet structure (shown as 130) (e.g., 0-level, low-level-high-level), and (ii) an encoded message 112 to be included in the specified packet structure. In some embodiments, the specified parket structure is selected based on the command 110. In some embodiments, the command 110 to the fiducial marker generator 114 includes the encoded message 112.

The fiducial marker generator 114, operatively coupled to the controller 118, is configured to (i) receive the command 110 and the encoded message 112, and (ii) determine a fiducial marker 116 that includes an encoded data packet, configured with the specified packet structure, having the encoded message 112.

The display 118 (shown as 118′), operatively coupled to the fiducial marker generator 114, is then configured to (i) receive the fiducial marker 116, and (ii) demonstrate (e.g., optically transmit or broadcast) the fiducial marker 116 to the receiver 104. The display 118 includes a set of pixels 119 that form the fiducial marker 116.

Receiver (104). In FIG. 1A, the receiver 104 includes a camera 120, a trained artificial intelligence (AI) model 124 (e.g., a convolutional neural network (CNN)), a packet structure identifier 128, and a controller 132. The camera 120 is configured to capture an image of a scene 122 that may include the fiducial marker 116. The trained AI model 124, integrated into the camera 120, is then configured to (i) determine a presence of the fiducial marker 116 in the image 122, and (ii) determine observable marker elements 126 (e.g., pixels) in the fiducial marker 116.

The packet structure identifier 128 is then configured to (i) receive, from the trained AI model 124, the observable marker elements 126 and (ii) determine the packet structure 130 using the observable marker elements, where the packet structure 130 is mapped to an arrangement of the observable marker elements 126 (e.g., pixels). The controller 132 is then configured to (i) receive, from the packet structure identifier 128, the packet structure 130, and (ii) decode the message included in the data packet encoded in the fiducial marker 116, where the data packet is configured with the packet structure 130, as specified by the transmitter 102.

Transceiver (106). In the example shown in FIG. 1B, the transceiver 106 includes the trained AI model 124, the packet structure identifier 128, the controller 134, and the fiducial marker generator 114. The trained AI model 124 is configured to (i) receive, from the camera 120, an image of a scene 122 that may include a first fiducial marker (shown as fiducial marker #1), (ii) determine the presence of the first fiducial marker in the image 122, and (iii) determine the observable marker elements 126 in the first fiducial marker. The trained AI model 124 is then configured to transmit the observable marker elements 126 to the controller 134 and the packet structure identifier 128. The first fiducial marker may include an encoded data packet configured with a packet structure.

The packet structure identifier 128 is configured to (i) receive, from the trained AI model 124, the observable marker elements 126 in the first fiducial marker, and (ii) determine the packet structure 130 of the data packet encoded in the first fiducial marker, using the observable marker elements 126, where the packet structure 130 is mapped to an arrangement of the observable marker elements 126 (e.g., pixels).

The controller 134 is configured to (i) receive, from the trained AI model 124, the observable marker elements 126 in the first fiducial marker, and (ii) decode, via a decoder 136, the message in the data packet encoded in the first fiducial marker. The controller 134 is then configured to (i) generate, via an application 140, a reply message 142 in response to the decoded message 138 (by the decoder 136), (ii) encode, via an encoder 144, the reply message 142, and (iii) transmit the encoded reply message 146 to the fiducial marker generator 114.

The fiducial marker generator 114, operatively coupled to the packet structure identifier 128 and the controller 134, is configured to (i) receive the packet structure 130 and the encoded reply message 146, and (ii) determine a second fiducial marker 148 (shown as fiducial marker #2) that includes an encoded data packet, configured with the packet structure 130, having the encoded reply message 146.

The display 118, operatively coupled to the fiducial marker generator 114, is then configured to (i) receive the second fiducial marker 148, and (ii) demonstrate (e.g., optically transmit or broadcast) the second fiducial marker 148 to other transducers or receivers.

Display (118). In some embodiments, the display 118 (see FIGS. 1A-1B) is a digital display (e.g., computer monitor, phone screen, etc.) having a plurality of pixels, where each pixel is configured to show an observable marker element 126 in a fiducial marker (e.g., 116, 148). In some embodiments, the display 118 is an electromechanical display having (i) a plurality of tiles, each configured to show an observable marker element 126 of a fiducial marker (e.g., 116, 148), and (ii) one or more actuators (e.g., servo motors) operatively coupled to the plurality of tiles, where the one or more actuators are configured to flip the plurality of tiles in accordance with an arrangement of the observable marker elements 126 in the fiducial marker (e.g., 116, 148). In some embodiments, each tile of the display 118 is a flapper or a printed placard.

FiducialMarker (116, 148). In some embodiments, the fiducial marker (116, 148) is generated or decoded according to a protocol defined by an adjustable AprilTag. In some embodiments, the fiducial marker (116, 148) is generated or decoded according to an adjustable protocol selected from or based on the group consisting of a QR code, a Ju marker, a Chroma tag, a Vu mark, a Topo tag, an S tag, and an ArUco tag.

TrainedAIModel (124). The trained AI model 124 was trained to detect and classify observable marker elements 126 using a set of fiducial markers (e.g., AprilTag, QR code, etc.) acquired from a set of images or a training dataset. In some embodiments, the AI model 124 was trained using fiducial markers and an associated number of observable marker elements as the training data.

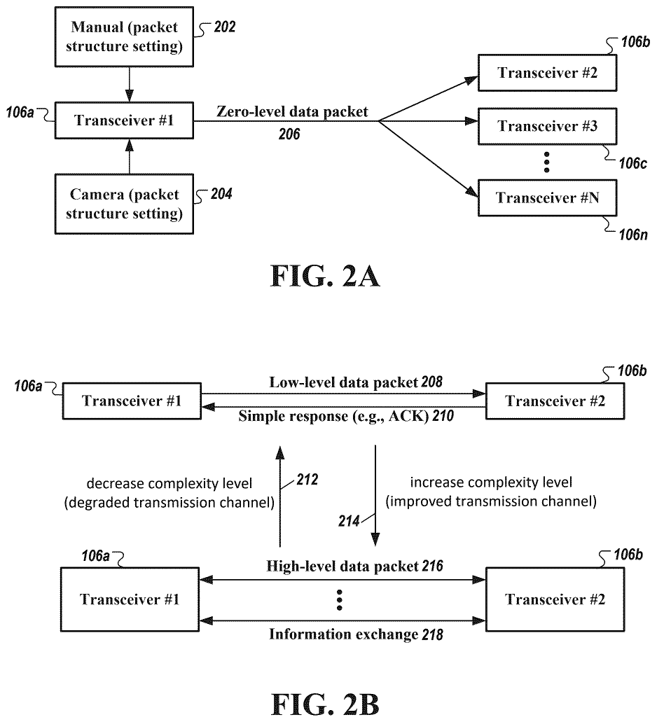

Packet Structure (130). In some embodiments, the packet structure 130 (i) is configured to be used in a data packet transmitted to a target, and (ii) includes a zero-level complexity indicator that the target does not need to respond (see FIG. 2A).

In some embodiments, the packet structure 130 (i) is configured to be used in a data packet transmitted to a target, and (ii) includes a low-level complexity indicator that the target generates a one-time response (e.g., confirmation, acknowledgement) (see FIG. 2B).

In some embodiments, the packet structure 130 (i) is configured to be used in a data packet transmitted to a target, and (ii) includes a high-level complexity indicator that the target initiates a subsequent serial exchange of messages with the data packet transmitter (see FIG. 2B).

Each type of packet structure 130 is mapped to a corresponding arrangement of the observable marker elements 126.

### Example Packet-Structure-Based Visual Communication

FIGS. 2A-2B show example types of packet-structure-based visual communication between communication systems (e.g., transceivers 106), in accordance with an illustrative embodiment. The transceiver 106 (e.g., 106a-106n) is configured to determine a packet structure (e.g., 130, FIGS. 1A-1B) of a data packet encoded in a fiducial marker (e.g., 116, 148, FIGS. 1A-1B), based on (i) predefined user configurations 202, or (ii) camera-based configuration 204, where the packet structure (e.g., 130, FIGS. 1A-1B) is mapped to an arrangement of one or more observable marker elements (e.g., 126, FIGS. 1A-1B) in a fiducial marker in a image (e.g., 122, FIGS. 1A-1B) acquired by a camera (e.g., 120, FIGS. 1A-1B).

FIG. 2A illustrates an example packet-structure-based one-way communication. As shown, the transceiver 106a (shown as transceiver #1) determines the packet structure (e.g., 130, FIGS. 1A-1B) of the data packet 206 to be zero-level and transmits the zero-level data packet 206 to transceivers 106b-106n (shown as transceivers #2-#n). The packet structure is a zero-level structure, so it includes a zero-level complexity indicator that the transceivers 106b-106n (also referred to as targets) do not need to respond to the transceiver 106a. As a result, after receiving the data packet 206 from the transceiver 106a, the transceivers 106b-106n (i) find the zero-level complexity indicator in the packet structure of the data packet 206 and (ii) do not send any responses back to the transceiver 106a.

FIG. 2B illustrates an example packet-structure-based two-way communication. As shown, the transceiver 106a determines the packet structure (e.g., 130, FIGS. 1A-1B) of the data packet 208 to be low-level and transmits the low-level data packet 208 to the transceiver 106b. The packet structure is a low-level structure, so it includes a low-level complexity indicator that the transceiver 106b needs to reply to the transceiver 106a with a one-time response (e.g., confirmation, ACK). As a result, after receiving the data packet 208 from the transceiver 106a, the transceiver 106b (i) finds the low-level complexity indicator in the packet structure of the data packet 208 and (ii) sends a one-time response 210 back to the transceiver 106a.

When a transmission channel allows for an increased complexity level of transmission 214, the transceiver 106a can determine the packet structure (e.g., 130, FIGS. 1A-1B) of the data packet 216 to be high-level and transmit the high-level data packet 216 to the transceiver 106b. The packet structure is a high-level structure, so it includes a high-level complexity indicator that the transceiver 106b needs to initiate a subsequent serial exchange of information 218 with the transceiver 106a. As a result, after receiving the data packet 216 from the transceiver 106a, the transceiver 106b (i) finds the high-level complexity indicator in the packet structure of the data packet 216 and (ii) initiates serial exchange of information 218 with the transceiver 106a. The transceivers 106a and 106b subsequently continue to exchange information (e.g., messages, data objects, etc.) until either transceiver terminates the communication.

When the transmission channel encounters a decrease in the complexity level of transmission 212, the transceiver 106a can switch from sending high-level data packets to sending low-level data packets to other transceivers 106, to save bandwidth for the transmission channel.

### Example Methods

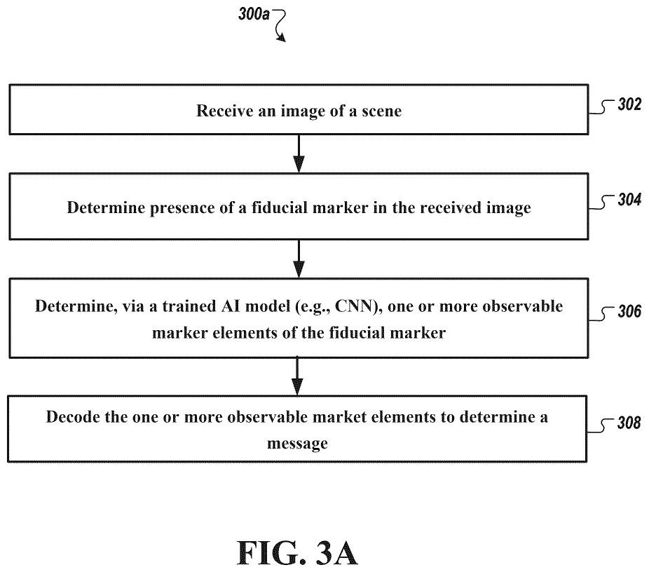

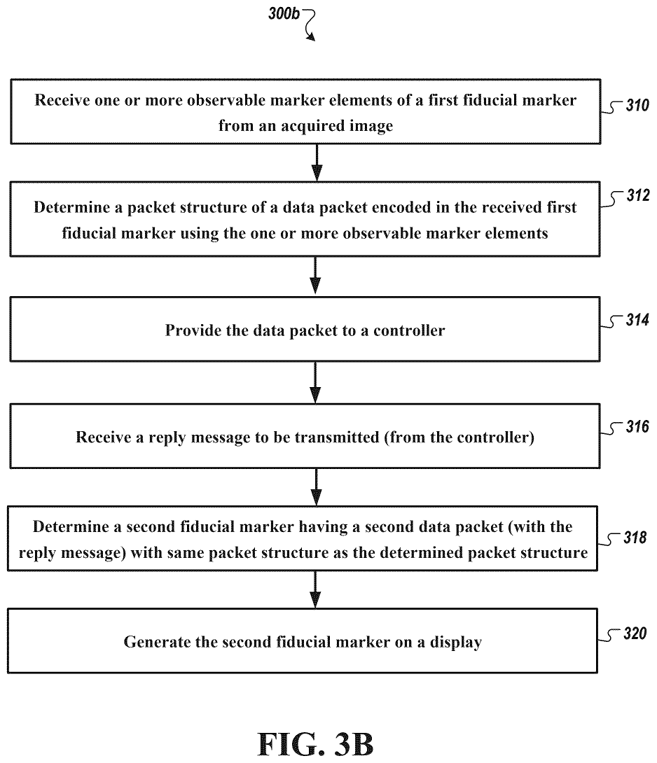

Method of Operating a Receiver. FIG. 3A shows an example method of operating a receiver (e.g., 104, FIG. 1A) of the exemplary system, in accordance with an illustrative embodiment. The method 300a includes receiving (302) an image of a scene (e.g., 122, FIGS. 1A-1B). The method 300a includes determining (304) presence of a fiducial marker (e.g., 116, FIG. 1A) in the received image (e.g., 122, FIGS. 1A-1B). The method 300a includes determining (306), via a trained AI model (e.g., 124, FIGS. 1A-1B), one or more observable marker elements (e.g., 126, FIGS. 1A-1B) of the fiducial marker (e.g., 116, FIG. 1A). The method 300a includes decoding (308) the one or more observable market elements (e.g., 126, FIGS. 1A-1B) to determine a message.

The trained AI model (e.g., 124, FIGS. 1A-1B) was trained to detect and classify observable marker elements (e.g., 126, FIGS. 1A-1B) using a set of fiducial markers (e.g., AprilTag, QR code, etc.) acquired from a set of images or a training dataset. In some embodiments, the AI model (e.g., 124, FIGS. 1A-1B) was trained using fiducial markers and an associated number of observable marker elements as the training data.

In some embodiments, the fiducial marker (e.g., 116, FIG. 1A) is generated or decoded according to a protocol defined by an adjustable AprilTag. In some embodiments, the fiducial marker (e.g., 116, FIG. 1A) is generated or decoded according to an adjustable protocol selected from or based on the group consisting of a QR code, a Ju marker, a Chroma tag, a Vu mark, a Topo tag, an S tag, and an ArUco tag.

Method of Operating a Transmitter. FIG. 3B shows an example method of operating a transmitter (e.g., 102, FIG. 1A) of the exemplary system, in accordance with an illustrative embodiment. The method 300b includes receiving (310) one or more observable marker elements (e.g., 126, FIGS. 1A-1B) of a first fiducial marker from an acquired image (e.g., 122, FIGS. 1A-1B). The method 300b includes determining (312) a packet structure (e.g., 130, FIGS. 1A-1B) of a data packet encoded in the received first fiducial marker using the one or more observable marker elements (e.g., 126, FIGS. 1A-1B). The method 300b includes providing (314) the data packet to a controller (e.g., 108, 134, FIGS. 1A-1B). The method 300b includes receiving (316) a reply message (e.g., 146, FIG. 1B) to be transmitted (from the controller). The method 300b includes determining (318) a second fiducial marker (e.g., 148, FIG. 1B) having a second data packet (with the reply message) with same packet structure as the determined packet structure (e.g., 130, FIGS. 1A-1B). The method 300b includes generating (320) the second fiducial marker (e.g., 148, FIG. 1B) on a display (e.g., 118, FIGS. 1A-1B).

In some embodiments, the display (e.g., 118, FIGS. 1A-1B) is a digital display (e.g., computer monitor, phone screen, etc.) having a plurality of pixels, where each pixel is configured to show an observable marker element (e.g., 126, FIGS. 1A-1B) in a fiducial marker (e.g., 116, 148, FIGS. 1A-1B). In some embodiments, the display (e.g., 118, FIGS. 1A-1B) is an electromechanical display having (i) a plurality of tiles, each configured to show an observable marker element (e.g., 126, FIGS. 1A-1B) of a fiducial marker (e.g., 116, 148, FIGS. 1A-1B), and (ii) one or more actuators (e.g., servo motors) operatively coupled to the plurality of tiles, where the one or more actuators are configured to flip the plurality of tiles in accordance with an arrangement of the observable marker elements (e.g., 126, FIGS. 1A-1B) in the fiducial marker (e.g., 116, 148, FIGS. 1A-1B). In some embodiments, each tile of the display is a flapper or a printed placard.

In some embodiments, the packet structure (e.g., 130, FIGS. 1A-1B) (i) is configured to be used in a data packet transmitted to a target, and (ii) includes a zero-level complexity indicator that the target does not need to respond (see FIG. 2A).

In some embodiments, the packet structure (e.g., 130, FIGS. 1A-1B) (i) is configured to be used in a data packet transmitted to a target, and (ii) includes a low-level complexity indicator that the target generates a one-time response (e.g., confirmation, acknowledgement) (see FIG. 2B).

In some embodiments, the packet structure (e.g., 130, FIGS. 1A-1B) (i) is configured to be used in a data packet transmitted to a target, and (ii) includes a high-level complexity indicator that the target initiates a subsequent serial exchange of messages with the data packet transmitter (see FIG. 2B).

Each type of packet structure (e.g., 130, FIGS. 1A-1B) is mapped to a corresponding arrangement of the observable marker elements (e.g., 126, FIGS. 1A-1B).

### Example Communication Flow

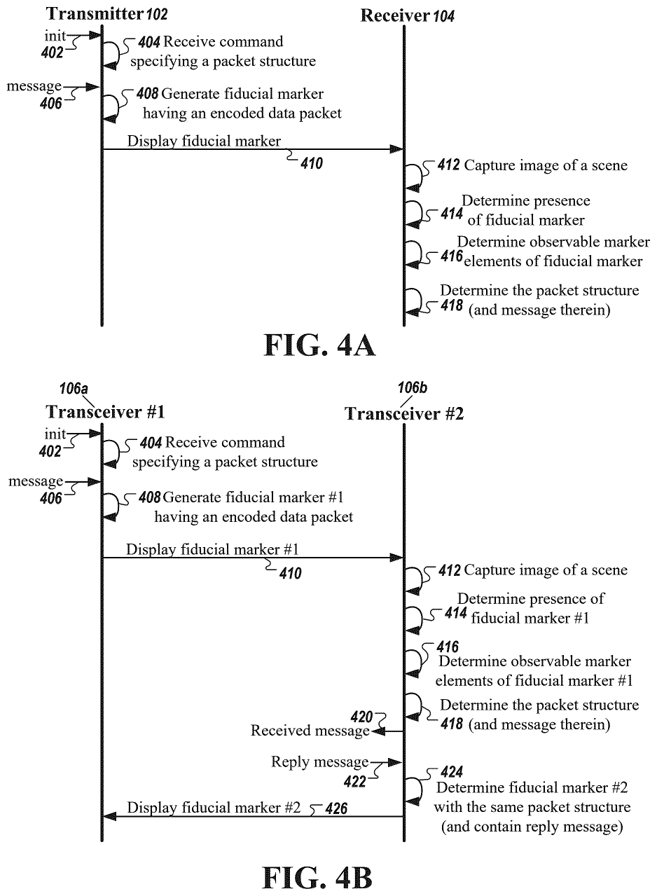

FIGS. 4A-4B show example communication flows between (i) a transmitter 102 and a receiver 104, and (ii) a transceiver 106a and a transceiver 106b, respectively, in accordance with an illustrative embodiment.

In the example shown in FIG. 4A, the communication flow starts when the transmitter initiates (402) its operation. The transmitter 102 then receives (404), from its controller (e.g., 108, FIG. 1A), a command (e.g., 110, FIG. 1A) specifying a packet structure (e.g., 130, FIG. 1A). The transmitter 102 then receives (406), from its controller, an encoded message (e.g., 112, FIG. 1A) to be included in the specified packet structure. The transmitter 102 then generates (408), via its fiducial marker generator (e.g., 114, FIG. 1A), a fiducial marker (e.g., 116, FIG. 1A) encoding a data packet configured with the specified packet structure that includes the encoded message (e.g., 112, FIG. 1A). The transmitter then demonstrates (410), via its display (e.g., 118, FIG. 1A), the generated fiducial marker (e.g., 116, FIG. 1A) to the receiver 104.

The receiver 104 captures (412), via its camera (e.g., 120, FIG. 1A), an image of a scene that may include the fiducial marker (e.g., 116, FIG. 1A) from the transmitter 102. The receiver 104 then determines (414), via its trained AI model (e.g., 124, FIG. 1A) a presence of the fiducial marker (e.g., 116, FIG. 1A) in the image (e.g., 122, FIG. 1A). The receiver 104 then determines (416), via its trained AI model (e.g., 124, FIG. 1A), observable marker elements (e.g., 126, FIG. 1A) in the fiducial marker (e.g., 116, FIG. 1A). The receiver 104 then determines (418), via its packet structure identifier (e.g., 128, FIG. 1A), the packet structure (e.g., 130, FIG. 1A) of the data packet encoded in the fiducial marker, using the determined observable marker elements (e.g., 126, FIG. 1A).

In the example shown in FIG. 4B, the communication flow starts when the transceiver 106a (shown as transceiver #1) initiates (402) its operation. The transceiver 106a then (i) receives (404), from its controller (e.g., 134, FIG. 1), a command specifying a packet structure (e.g., 130, FIG. 1), or (ii) determines, from its packet structure identifier (e.g., 128, FIG. 1), a packet structure (e.g., 130, FIG. 1), using observable marker elements (e.g., 126, FIG. 1B) in a fiducial marker received from other transceivers or transmitters. The transceiver 106a then receives (406), from its controller (e.g., 134, FIG. 1B), an encoded reply message (e.g., 146, FIG. 1B) to be included in the specified packet structure (e.g., 130, FIG. 1B). The transceiver 106a then generates (408), via its fiducial marker generator (e.g., 114, FIG. 1B), a first fiducial marker (shown as fiducial marker #1) encoding a data packet configured with the specified packet structure that includes the encoded reply message (e.g., 146, FIG. 1B). The transceiver 106a then demonstrates (410), via its display (e.g., 118, FIG. 1B), the first fiducial marker to the transceiver 106b.

The transceiver 106b (shown as transceiver #2) captures (412), via its camera (e.g., 120, FIG. 1B), an image of a scene that may include the first fiducial marker from the transceiver 106a. The transceiver 106b then determines (414), via its trained AI model (e.g., 124, FIG. 1B), a presence of the first fiducial marker in the image (e.g., 122, FIG. 1B). The transceiver 106b then determines (416), via its trained AI model (e.g., 124, FIG. 1B), observable marker elements (e.g., 126, FIG. 1B) in the first fiducial marker. The transceiver 106b then determines (418), via its packet structure identifier (e.g., 128, FIG. 1B), the packet structure (e.g., 130, FIG. 1B) of the data packet encoded in the first fiducial marker, using the determined observable marker elements (e.g., 126, FIG. 1B). The transceiver 106b then extracts (420), via its decoder (e.g., 136, FIG. 1B) of its controller, a message (e.g., 138, FIG. 1B) from the encoded data packet. The transceiver 106b then generates (422), via an application on its controller, a reply message (e.g., 142, FIG. 1B), in response to the extracted message (e.g., 138, FIG. 1B). The reply message is subsequently encoded, via an encoder (e.g., 144, FIG. 1B) of the transceiver 106b's controller, into an encoded reply message (e.g., 146, FIG. 1B). The transceiver 106b then determines (424), via its fiducial marker generator (e.g., 114, FIG. 1B), a second fiducial marker (shown as fiducial marker #2) (e.g., 148, FIG. 1B) encoding a data packet, configured with the same determined packet structure (e.g., 130, FIG. 1B), that includes the encoded reply message (e.g., 146, FIG. 1B). The transceiver 106b then demonstrates (426), via its display (e.g., 118, FIG. 1B), the second fiducial marker to the transceiver 106b.

### Example Fiducial Marker

A fiducial marker (e.g., AprilTag) is a reference object or pattern placed within a visual field to facilitate spatial measurements, alignment, or tracking by imaging systems. These markers may include high-contrast, geometrically distinct patterns (e.g., black-and-white squares, concentric circles, encoded grids, etc.) configured to be detectable and decodable by computer vision algorithms. Fiducial markers may be physical (e.g., printed on paper, etched onto surfaces, embedded in hardware, etc.) or digital (e.g., rendered within a graphical user interface, augmented reality environment, virtual simulation, etc.). Digital fiducial markers can be useful in software-based systems, where they can be generated, positioned, and scaled to support real-time calibration and spatial referencing without requiring physical placement.

Fiducial markers may be placed on flat surfaces, embedded in three-dimensional structures, or affixed to moving objects. Their placement is optimized to ensure visibility from various angles and maximize coverage within a sensor's field of view. The markers may encode unique identifiers or spatial coordinates, enabling the imaging system to distinguish between markers and determine their relative positions and orientations. Fiducial markers are used in robotics, augmented reality, autonomous navigation, and medical imaging, where precise localization and alignment are critical to system performance.

AprilTag (AT). In some embodiments, AprilTag is a fiducial marker (e.g., 116, 148, FIGS. 1A-1B) recognized and generated by the exemplary system. An AprilTag can include (i) a static external black border to assist detection and (ii) an inner payload region where square bits can be changed from black to white to encode information. The AprilTag can be customized for various tag families and integrated into computer vision frameworks (e.g., OpenCV, image processing libraries, etc.) for plug-and-play operation. The AprilTag can also include an error correction technique configured to classify and correct bit errors in the encoded payload, thereby improving reliability in noisy or low-resolution imaging environments.

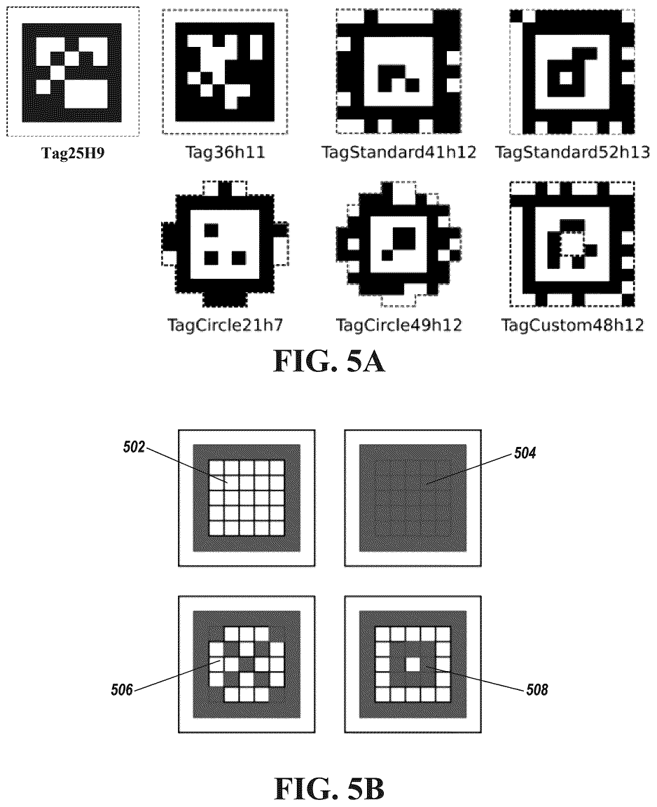

FIG. 5A shows example AprilTag fiducial markers from various AprilTag families. As shown, each AprilTag includes a border region and a center region (e.g., payload region). The border region can include a solid, static border that cannot change. Besides providing contrast from the background surfaces, the border region can be used for both image correction and localization of the image. In some embodiments, the AprilTag is a square fiducial marker/tag, and a vision system uses this knowledge to determine the pose of the AprilTag relative to a sensor (e.g., camera), detecting the AprilTag in 6 degrees of freedom (DOF), with three DOF attributing to rotation and the other three attributing to translation. When the sensor (e.g., a camera) is positioned in front of an AprilTag and aligned perpendicularly to its surface, the AprilTag may appear as a square in the captured image. However, if the sensor is angled or offset laterally (e.g., the sensor views the AprilTag from the side), the AprilTag may appear distorted, taking on a rectangular or trapezoidal shape due to perspective projection. Computer vision systems or software (e.g., a trained AI model 124, FIGS. 1A-1B) can analyze the distortion of the AprilTag in the captured image and estimate its pose (e.g., orientation and position relative to the sensor) by calculating the transformation needed to correct the distorted appearance back to the expected square geometry. The AprilTag can have a circular form factor and use the pixels of the outer border to encode information.

In some embodiments, the exemplary system uses the Tag 25H9 configuration in the AprilTag families (see FIG. 5A), where “25” refers to the number of pixels, or bits, in the center (also referred to as payload), and H9 refers to the hamming distance of the tag of the exemplary system. The 25 center bits, or the payload, of the AprilTag may be controlled for transitioning from one AprilTag to another. The more controllable bits within the display (e.g., 118, FIGS. 1A-1B), the more unique AprilTags that the display (e.g., 118, FIGS. 1A-1B) can produce, which can increase the number of data packets or messages that the display (e.g., 118, FIGS. 1A-1B) can transmit. Conversely, the more bits that need to be controlled, the more hardware or electronics (e.g., actuators) are required to support their operation.

The fewer bits that may be processed, the faster the exemplary system can identify an AprilTag. A lower decoding load can improve detection speed and reduce computational complexity. Furthermore, the fewer bits in a tag family can affect detection distance: families with fewer bits can be detected farther away due to their simple and distinguishable visual patterns. In some embodiments, the 25H9 AprilTag family is utilized to balance the tradeoff between information density, system complexity, and detection distance.

Within the 25H9 AprilTag family, because 25 pixels can change between two states (e.g., colored/non-colored, black/white, etc.), there can be 2²⁵ AprilTag configurations, or 33.6 million different 5-by-5 AprilTags. However, there are only 35 valid AprilTags out of 33.6 million in the 25H9 family, because of two constraints. First, AprilTags are rotationally invariant, as an AprilTag rotated by 0°, 90°, 180°, or 270° can be recognized, by a trained AI model (e.g., 124, FIGS. 1A-1B) or detection algorithm, as the same AprilTag. The same trained AI model or detection algorithm can also output the rotation angle of the detected tag as an additional output of the exemplary system. Second, the 25H9 AprilTag family enforces a minimum hamming distance of 9, requiring each valid tag to differ from others by at least 9 bits. The hamming distance can enhance error resilience but reduce the number of usable tag configurations.

The hamming distance refers to how unique an AprilTag is from another to prevent mislabeling or confusion. In the 25H9 AprilTag family, of the 25 bits within this family's payload, 9 of the bits should be different [1]. If the trained AI model (e.g., 124, FIGS. 1A-1B) or detection algorithm has trouble reading a few bits within the payload, the hamming distance between known tags helps identify the intended tag even though errors are present.

### Example Data Packet Structure

Configurations of the Packet Structures. In some embodiments, the exemplary system employs 4 data packets, each with a different packet structure (e.g., 130, FIGS. 1A-1B). Three of the packet structures (e.g., 130, FIGS. 1A-1B) use AprilTags to relay information in the data packet or message encoding, while one uses non-AprilTag configurations.

In some embodiments, the non-AprilTags are utilized to broadcast bidirectional feedback during communication or system status/state to nearby humans or other systems. FIG. 5B shows example display states that are broadcast using non-AprilTags, including the exemplary system being all off (502), all on (504), occupied (506) (e.g., conducting operations), or idle (508) (e.g., ready to receive commands). All these states are used as cues to broadcast system statuses when the exemplary system is not being used to actively communicate.

The uses of the three packet structures that use AprilTags are shown as follows. The first packet structure, referred to as a 0-level packet structure, is used to transmit data packets or messages that need no response or confirmation (see FIG. 2A). The priority of the 0-level packet structure is transmission speed over information density, so they only require one AprilTag for broadcast and are reserved for confirmation packets or messages, changes in internal functionality, faults, and feedback during collaborative or precision operations.

In some embodiments, the other two packet structures, including low-level and high-level packet structures, are used for coordination between two parties, relaying information or data, or queuing up collaborative operations (see FIG. 2B). The low-level and high-level packet structures can be formatted using three reserved AprilTags. The low-level packet structure can include 3 bits, with the first bit reserved for displaying AT32, which is the 33^{rd} AprilTag in a base-O-index AprilTag system. The second and third bits in the low-level packet structure display any of the first 32 AprilTags, allowing for 1,024 possible low-level packet structures.

The high-level or complex packet structure is the most information-dense of the three packet structures, so the high-level packet structure is used to transmit data, coordinate complex operations, or transmit information that requires contextual information not available in the 0-level or low-level packet structures. The 0-level, low-level, and high-level packet structures that the exemplary system employs are defined per Equations 1, 2, and 3, respectively.

$$0 - level = [ Msg AT ] \qquad ( Eq . 1 )$$

$$Low - level = [ Init AT ] [ Msg AT ] [ Msg AT ] \qquad ( Eq . 2 )$$

$$High - level = [ Init AT ] [ Task AT ] [ Msg AT ] [ Conf AT ] [ Term AT ] \qquad ( Eq . 3 )$$

Packet Structure Identification. The exemplary system is configured to identify different packet structures using the differentiators between them. The first differentiator the exemplary system uses can be the presence of AprilTags. The non-April Tag display states may not be used during the broadcast of any formatted packet structures, so the exemplary system may only attempt to decode packet structures that contain AprilTags. The second differentiator can be the time delay between display states (e.g., colored/non-colored, black/white, etc.). A binary packet structure is the only packet structure that does not adhere to the standard time delay. If the exemplary system detects an AprilTag that does not adhere to the standard time delay, then the AprilTag can be classified as a binary packet structure, and the exemplary system can respond accordingly.

If the April Tag changes from one tag to another based on the standard time delay, the exemplary system can classify the packet structure as a high- or low-level. Once classified as a high- or low-level packet structure, the exemplary system can wait to detect AT32 or AT33, which can be used as the packet initiator tags for the low-level and high-level packet structures, respectively. If AT32 is detected, the exemplary system can decode the two AT payload bits and respond accordingly.

If AT33 is detected, the exemplary system can classify the packet structure as a high-level packet structure and store the AprilTags that follow AT33 in a queue until AT34 is broadcast. This is because the exemplary system may use four variants of the high-level packet structure, the difference between which is the number of payload bits in the packet structure. This can provide functionality where up to 1,048,576 packet structures can be encoded in the largest high-level format.

Two other bits of information within the high-level packet structure can provide additional functionality. The first bit is a second bit in the packet structure, a task classifier that can clarify the purpose of the broadcast packet structure, including a data request, a data transmission, a request for collaborative operation, an indicator of a hazard, etc. The task classifier can be utilized to streamline the post-processing of decrypted packet structures, given that the intent of the packet structure is explicitly expressed by the identifier. The second bit is the second-to-last bit of the packet structure, a confirmation classifier configured for error correction or as a differentiator between different broadcast targets. For error correction, the second bit can be utilized as an acknowledgement (ACK) or non-acknowledgment (NACK) bit. Given that 32 possible AprilTags can be used, different ACK or NACK signals can be broadcast based on packet structure requirements. Additionally, the second bit can be utilized to direct data packets or messages to a specific target when multiple targets are positioned to receive the broadcast.

Error Correction Protocol. In some embodiments, the exemplary system employs an error correction protocol to assess broadcast and reception errors. The error correction protocol is configured to finalize the validity of the received packet structure, before transmitting decoded commands to a controller (e.g., 132, 134, FIGS. 1A-1B) of the exemplary system. The trained AI model (e.g., 124, FIGS. 1A-1B) or detection algorithm of the exemplary system can employ a cyclic redundancy check (CRC) algorithm that compares the received packet structure to known packet structures or message sequences stored in the controller (e.g., 132, 134, FIGS. 1A-1B). If the trained AI model or detection algorithm detects AT32 followed by anything other than two AprilTags ranging from ATO to AT31, then the trained AI model or detection algorithm can indicate that there is a partial detection of a low-level packet structure and provide the percent confidence in the detected packet structure.

### Example Fiducial Marker Detection Algorithm

In some embodiments, the controller (e.g., 132, 134, FIGS. 1A-1B) of the exemplary system is configured to execute a fiducial marker detection algorithm with four operations. The first operation is initializing a data pipeline between the controller (e.g., 132, 134, FIGS. 1A-1B) (e.g., Raspberry Pi) and the trained AI model (e.g., 124, FIGS. 1A-1B). The pipeline is configured to define the input data provided to the trained AI model (e.g., 124, FIGS. 1A-1B), and output data transmitted from the AI model to the controller (e.g., 132, 134, FIGS. 1A-1B). The output data may include a detected fiducial marker (e.g., AprilTag) and its metadata (e.g., size and location of its bounding box).

The second operation is executing the detection of AprilTags and the classification of packet structures encoded in the AprilTags. In some embodiments, two differentiators are used for decoding packet structures: the delay between AprilTags and known packet structure sequences. When the trained AI model detects an AprilTag, it starts recording the sequence of detected AprilTags in a queue. If the delay between AprilTags exceeds a predefined delay interval, then the package structures are classified, via a packet structure identifier (e.g., 128, FIGS. 1A-1B), as binary (e.g., zero-level package structures). If the delay between AprilTags meets the predefined delay interval, then the packet structures are classified, via the packet structure identifier (e.g., 128, FIGS. 1A-1B), as low or high-level packet structures.

The detection algorithm is configured to monitor for the presence of fiducial markers AT32, AT33, or AT34. Upon detection of AT32, the package structure is classified as a low-level packet structure. In response, any previously recorded ATs are purged from the queue, and the detection algorithm awaits the next two payload ATs required for a packet structure to match the low-level packet structure format. These payload ATs are then parsed out for decoding. A similar process is initiated upon detection of AT33. In this case, the package structure is classified as a high-level packet structure. The queue then records the sequence of ATs until AT34 is received. Upon detection of AT34, the queue is classified as a high-level package structure, and the detection algorithm parses and stores the Task AT, the Payload ATs, and the Confirmation AT for decoding.

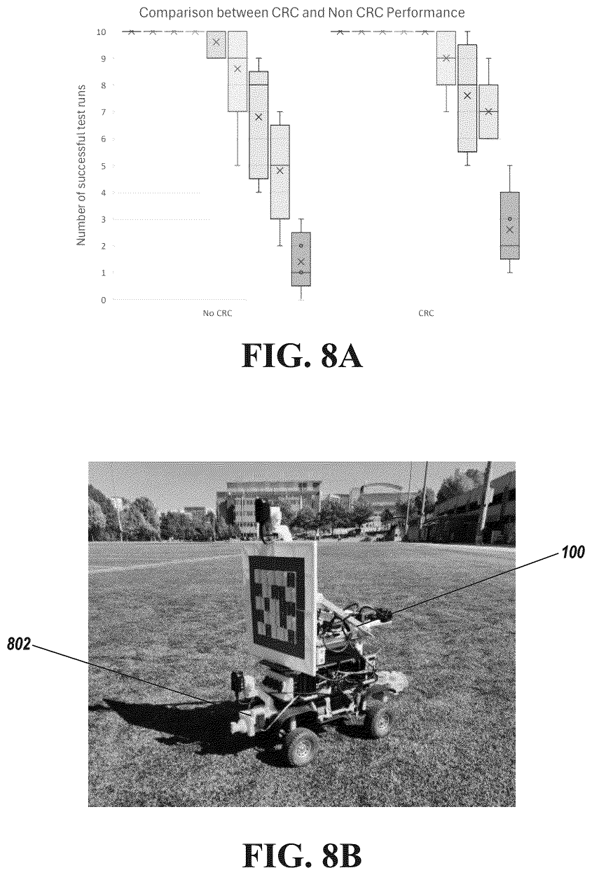

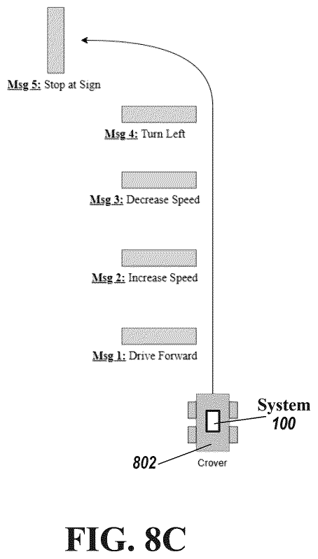

The third operation is decoding the detected package structure (and message therein). There are three packet structure types: 0-level, low-level, and high-level. The 0-level and low-level packet structures are configured to relay pre-defined, abstract data used by an external platform (e.g., Crover 802, FIG. 8B) (e.g., to provide operational feedback, coordinate actions, or execute automated subroutines) that is coupled to the exemplary system. The high-level packet structures are configured to transmit complex abstract data coupled with additional contextual information (e.g., specific tasks or intended recipients) or discrete data. The decoded packet structure (and message therein) can then be formatted for transmission to a target or the external platform (e.g., Crover).

The fourth operation is transmitting, via the electromechanical display (e.g., 118, FIGS. 1A-1B), the decoded packet structure (and message therein) to the external platform (e.g., Crover).

### Example Electromechanical Display

In the exemplary system, the electromechanical display includes a set of electromechanical pixels (e.g., 119, FIG. 1A) (e.g., 35 mm×35 mm), where each pixel includes an actuator, a flapper, and a support structure. The support structure (also referred to as a pixel base) acts as a mount for an actuator and a hinge for a flapper. The flapper is a substrate where two pigments of the display are attached, and the actuator is used to change which side of the flapper is visible, thus exposing one pigment or another.

Actuator-Flapper Assemblies. To support the functions of the actuator, flapper, and support structure, the display (e.g., 118, FIGS. 1A-1B) and its pixels (e.g., 119, FIG. 1A) should satisfy some mechanical/geometric and control constraints. Table 1 shows example geometric constraints for each pixel of the display.

TABLE 1

Constraints
The footprint (e.g., planar area, rotational area) of each
pixel should be square to allow symmetric packing and
support the production of the April Tag fiducial markers.
During actuation, none of the pixels can extend beyond the
footprint to eliminate the possibility of contact
with other pixels that may impede the operation of a pixel.
The depth of a pixel should be defined by the actuation
mechanism and actuation clearance of the flapper.

Table 2 shows mechanical and control constraints for the electromechanical display.

TABLE 2

| | |
|---|---|
| Mechanical | Flip each flapper 180° to show both pigmentation |
| constraints | configurations. |
| | Actuators should be available “off-the-shelf”. |
| | Low power draw (e.g., peak power draw under 25 W, |
| | continuous power draw under 5 W). |
| | Actuation mechanisms should be as small as possible. |
| Control | Directly interface with a controller (e.g., 108, |
| constraints | 134, FIGS. 1A-1B) (e.g., Raspberry Pi). |
| | Synchronous actuation. |
| | Synchronous control. |

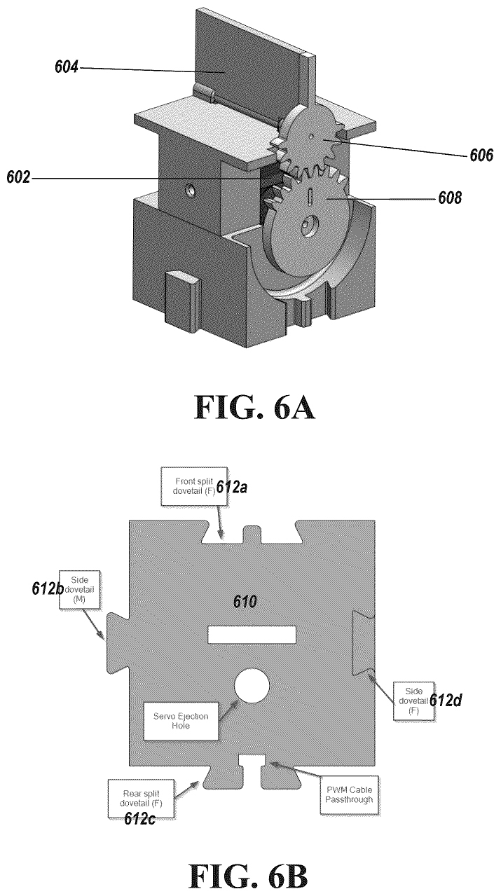

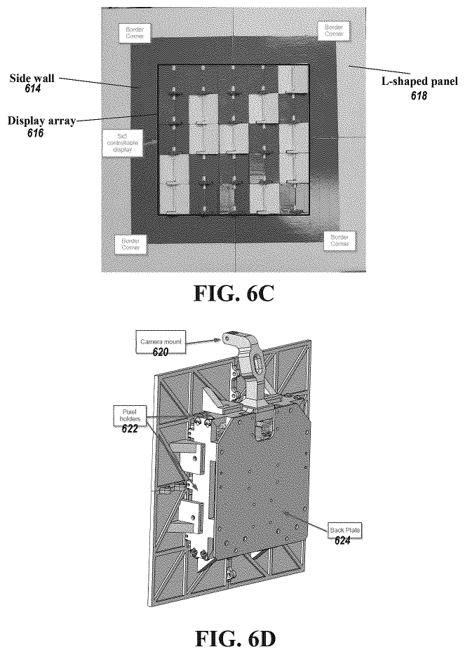

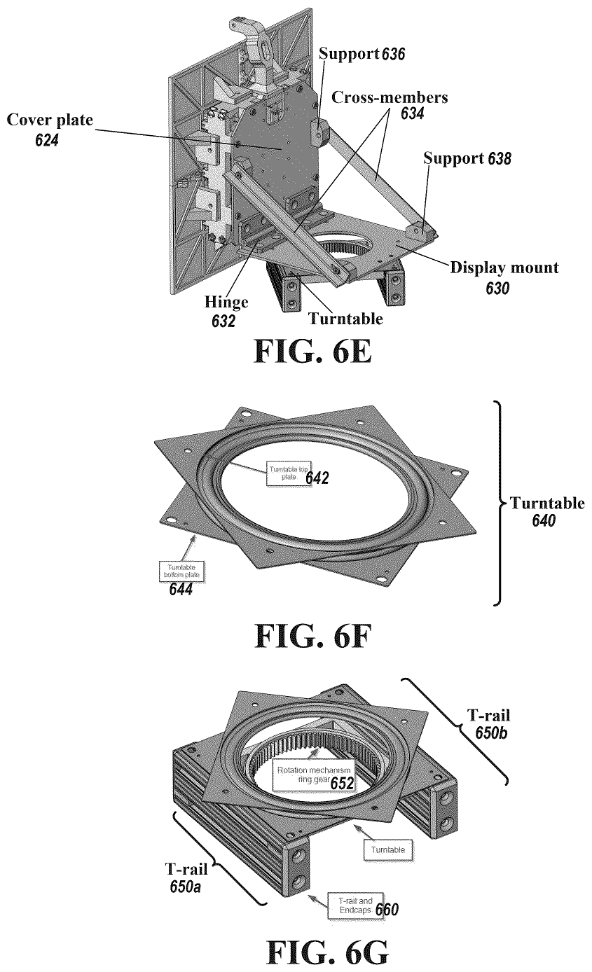

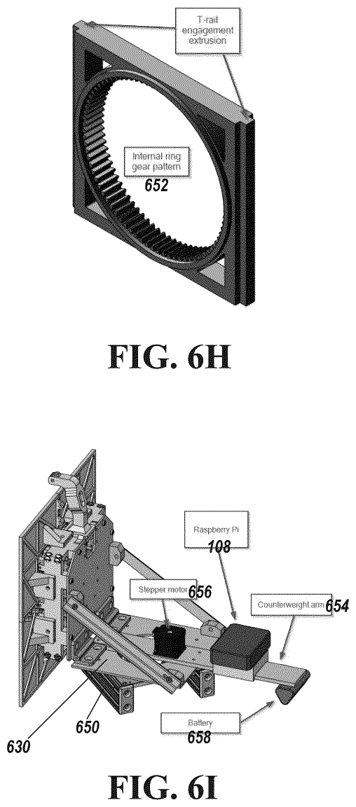

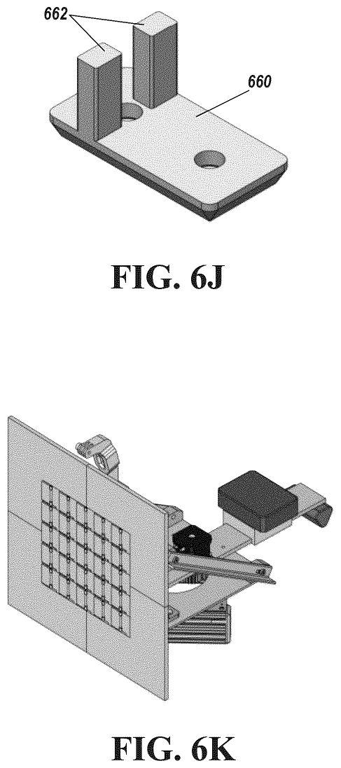

The function of the electromechanical display (e.g., 118, FIGS. 1A-1B) requires that a visible portion of the display make a binary change of its color state, which can be achieved with rotational actuation of the flapper. In some embodiments, the display employs a plurality of actuator-flapper assemblies, each assembly having a rotational actuator (e.g., servo motors) mechanically coupled to a flapper using mated spur gears. FIG. 6A shows an example actuator-flapper assembly, where a rotational actuator 602 is mechanically coupled to a flapper 604 using mated spur gears 606 and 608. For the flapper 604 to rotate 180°, the spur gears 606 and 608 may be made with a 2:3 gear ratio. The larger gear 608 is configured to mate with an output hub on the actuator 602, and the smaller gear 606 is integrated into the flapper 604. In some embodiments, to prevent the risk of the actuator 602 overdriving the flapper 604, the smaller gear 606 on the flapper 604 is configured with teeth only ±60° to the plane of the flapper 604.

Pixel Base. To support an actuator-flapper assembly, a pixel base is configured as a mount for an actuator and a hinge for a flapper. FIG. 6B shows an example pixel base 610 to support an actuator-flapper assembly. FIG. 6C shows a front view of an electromechanical display (e.g., 118, FIGS. 1A-1B).

In FIG. 6B, the pixel base 610 (e.g., 35 mm×35 mm) is configured to accommodate the passage of the actuator cable and the geartrain (e.g., mated spur gears 606 and 608) that transfers the actuation motion to the flapper (e.g., 604, FIG. 6A). The actuator (e.g., 602, FIG. 6A) can be small, so the pixel base 610 should fill a certain amount of volume so that the pixel (e.g., 119, FIG. 1A) can be square. In some embodiments, the pixel base 610 is three-dimensional (3D) printed using PETG filament to vary the infill volume and pattern to maintain strength whilst reducing weight of the pixel base 610. To further reduce the weight of each pixel base 610, pixels can be joined using constrained dovetail joints (e.g., 612a-612d) on the sides of the pixel base 610. The dovetails 612a-612d on the sides of pixel bases 610 ensure that when adjacent pixels are assembled, they may sit flat next to each other.

In FIG. 6C, the dovetails (e.g., 612a-612d, FIG. 6B) are integrated into the side walls 614 (also referred to as side borders or panels) of the display. In some embodiments, to assemble a 5×5 display array 616 (also referred to as pixel array), 5 pixels are mated from left to right to make a row, and 5 separate rows are made in this manner to make a 5×5 square array of pixels; the side walls 614 are then mated to the dovetails (e.g., 612a-612d, FIG. 6B) in the 5×5 square, and once all the side walls 614 have been mated, their corners are bolted, which locks the array 616 in place.

The display array 616 corresponds to an interior portion (e.g., display array) that changes with each of the 35 different AprilTags in the 25H9 tag family, representing some main features (e.g., interior pattern, error detection and correction, etc.) of an AprilTag (see FIG. 5A). AprilTags also require (i) a pigmented perimeter surrounding the changing interior portion and (ii) a white perimeter surrounding the pigmented perimeter, both of which facilitate locating the AprilTag by providing a background that contrasts with the environmental background. In some embodiments, the white perimeter is formed of “L” shaped panels 618 that mount to the corners of the side walls 614 of the display array 616.

Camera Mount. A camera (e.g., 120, FIGS. 1A-1B) should be integrated, via camera mount (e.g., 620, FIG. 6D), into the electromechanical display (e.g., 118, FIGS. 1A-1B) and tied to both the power and control systems (e.g., 108, 132, 134, FIGS. 1A-1B), facilitating that (i) a single display on its corresponding mount can represent a full communication system with both transmission and reception capabilities, and (ii) the motion of the transmitter (e.g., 102, FIG. 1A) and receiver (e.g., 104, FIG. 1A) can be coupled so that during active communication, both transmission and reception can be possible. This may mimic eye contact in biological systems where non-verbal messages can be transmitted by directly monitoring another subject.

FIG. 6D shows an example electromechanical display with an integrated camera mount 620. As shown, a camera (i) can be mounted to the top of a pixel holder 622 (also referred to as a display array holder) containing the display array (e.g., 616, FIG. 6C) and associated electronics (e.g., actuators) and (ii) extends over the perimeter border of the display (e.g., 118, FIGS. 1A-1B). This ensures that the camera's presence does not interfere with the transmission of data packets or messages, and the camera is in the best position to receive data packets or messages directed towards the display.

In FIG. 6D, a cover plate 624 (shown as a back plate) is mounted to the back of the display array to complete the assembly of the display (e.g., 118, FIGS. 1A-1B). The cover plate 624 is configured to (i) protect the actuators (e.g., 602, FIG. 6A) and their cable connections with flappers (e.g., 604, FIG. 6A) in the display array 616, (ii) provide a solid mounting surface for the controller of the display (e.g., 108, 134, FIGS. 1A-1B) (e.g., PWM driver board), and (iii) provide an interface to integrate the display into a display mount (e.g., 630, FIG. 6E). In some embodiments, the cover plate 624 is bolted to the side walls 614.

Display Mount and Turntable. Table 3 shows example constraints on the display mount 630 for the electromechanical display.

TABLE 3
Constraints for the display mount
The display array should be perpendicular to the base of the
display mount 630 (also referred to as the
display's base plate), but adjustable to ±10° of tilt.
The center of gravity of the display should be within the
footprint of the base of the display mount 630.
The display mount 630 should facilitate 360° articulation of the display.

For the display array (e.g., 616, FIG. 6C) to tilt±10° from the perpendicularity with the base of the display mount, the display mount should not be rigidly affixed to the cover plate (e.g., 624, FIG. 6D) of the display array, which can be achieved using a hinge and cross-members. FIG. 6E shows an example integration of the display array with a display mount 630 and cross-members 634. As shown, the hinge 632 (e.g., acrylic hinge) is configured to (i) join the display mount 630 and the cover plate 624 and (ii) provide mechanical support for the display array (e.g., 616, FIG. 6C) to stay stable at ±10° articulation. The cross-members 634 (e.g., aluminum cross-members) are configured to fix the articulation of the display array. The cross members 634 are bolted to supports 636 and 638 on the cover plate 624 and the base of the display mount 630, respectively. In some embodiments, each cross-member 634 is bolted to the display array (e.g., 616, FIG. 6C) through a hole, but it mounts to the display mount 630 through a slot. The slot facilitates the display array to be articulated to a desired position and then bolted into place.

In some embodiments, the electromechanical display (e.g., 118, FIGS. 1A-1B) is located on a turntable that can support a rotation mechanism (e.g., by a ring gear). The turntable should be low-weight, have a large outer diameter to promote axial stability, and have a large inner diameter to facilitate electrical connections between the display and an external platform (e.g., autonomous vehicle, boat, etc.). FIG. 6F shows an example turntable 640 for the electromechanical display. As shown, the turntable 640 includes a top plate 642 and a bottom plate 644. In some embodiments, the turntable 640 is configured for a maximum compressive axial load of 300 pounds, but it also supports tensile axial loads and bending moments due to its enclosed fabrication. In some embodiments, the turntable 640 has a square outer footprint of 162.4 mm×162.4 mm, which can facilitate an installation of the display 118 into an external platform (e.g., Crover 802, FIG. 8B). In some embodiments, the inner diameter of the turntable 640 is 120 mm, providing room for the electrical connections and for any rotation mechanisms (e.g., by a ring gear).

In some embodiments, the top plate 642 is coupled to the display mount, and the bottom plate 644 is coupled to an interface for mounting to an external platform (e.g., Crover). FIG. 6G shows an example mounting interface to an external platform (e.g., Crover) coupled to the bottom plate of the turntable (e.g., 640, FIG. 6F). The mounting interface is configured to (i) be a stable mechanical interface for integrating the display (e.g., 118, FIGS. 1A-1B) and the external platform, and (ii) provide an installation location for a display rotation mechanism (e.g., by a ring gear). In FIG. 6G, the mounting interface includes two T-rails 650a and 650b (e.g., 50 mm×25 mm) that have a low weight and provide the flexibility for mounting components on either of their sides without machining.

Rotation Mechanism. The rotation mechanism, configured for the display mount (e.g., 630, FIG. 6E), should have sufficient torque to rotate the electromechanical display (e.g., 118, FIGS. 1A-1B) and hold the display in position when rotation is unnecessary. The rotation mechanism should also be configured for continuous, 360° rotations.

FIG. 6H shows an example ring gear configured as a rotation mechanism for the display mount. FIG. 6I shows an example electromechanical display system employing a rotation mechanism and a counterweight arm 654.

In FIG. 6H, the rotation mechanism is configured to be an internal ring gear 652 mounted inside the T-rail (e.g., 650a-650b, FIG. 6G) that may mesh with a pinion gear to drive the rotation. In FIG. 6I, a stepper motor 656 is configured to drive the rotation mechanism, and an optical interrupt (not shown) is used as a noncontact homing switch. The stepper motor 656 may have a pinion gear on its shaft (e.g., D-cut shaft) that it can use to drive the rotation of the base of the display mount 630 relative to the external platform (e.g., Crover 802, FIG. 8B).

In FIG. 6I, the stepper motor 656 is mounted to the counterweight arm 654 bolted to the base of the display mount 630. The counterweight arm 654 is configured as a mounting location for the stepper driver (not shown), the controller 134 of the display (e.g., Raspberry Pi), and the battery 658, all of which are positioned to balance the center of gravity of the entire electromechanical display (e.g., 118, FIGS. 1A-1B). In some embodiments, the pinion gear and the ring gear are 3D printed using PETG.

FIG. 6J shows an example T-rail end cap 660 configured to fix and center the ring gear of the rotation mechanism. In some embodiments, the ring gear is retained between two T-rails (e.g., 650a-650b, FIG. 6G), using two structural configurations. The first configuration includes a negative profile of a T-rail slot formed on opposing sides of the ring gear (e.g., 652, FIG. 6H), which allows the ring gear to recess into the T-rail slot, constraining its position along the X and Z axes.

The second configuration provides a constraint along the Y-axis. Specifically, the ends of the T-rails (e.g., 650a-650b, FIG. 6G) can be fitted with end caps 660. Each T-rail can include a central hole (e.g., 6.35 mm) that is tapped to receive a fastener, securing the end caps 660 to the ends of the T-rail. The end caps 660 include extrusions 662 that slide into the T-rail slots and engage the sides of the ring gear, thereby inhibiting lateral movement and constraining the ring gear along the Y-axis.

FIG. 6K shows a front view of a complete electromechanical display system.

### Example Electrical and Control Configurations

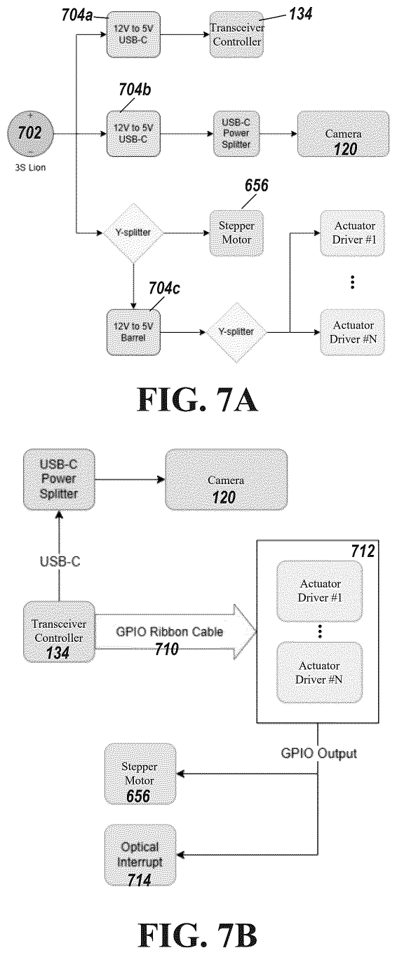

FIG. 7A shows an example electrical configuration for the transceiver (e.g., 106, FIG. 1B) of the exemplary system. In some embodiments, the transceiver is powered by a 12V Lithium-Ion battery 702. The electronic components within the transceiver operate at 5V, so they may require voltage regulators 704a-704c configured to convert 12V to 5V. The stepper motor 656 is an exception, as it is powered directly by the 12V battery 702 without voltage regulation.

Each voltage regulator 704a-704c supplies power to a distinct electronic component. The voltage regulator 704a powers the controller 134 (e.g., Raspberry Pi 4) configured to control the transceiver and the electromechanical display thereon. The voltage regulator 704b powers the actuator drivers configured to drive the actuators (e.g., 602, FIG. 6A) that control the flappers (e.g., 604, FIG. 6A). The voltage regulator 704c powers the camera 120 (e.g., Oak-1 camera).

FIG. 7B shows an example control configuration of the transceiver (e.g., 106, FIG. 1B). In some embodiments, the controller 134 is connected to the actuation drivers (e.g., I2C PWM actuator bonnets 712) via a GPIO ribbon cable 710 dedicated to I2C communication. In some embodiments, the controller 134 is also configured to communicate, via the GPIO ribbon cable 710, with (i) the stepper motor 656 to rotate the electromechanical display (e.g., 118, FIG. 1B) on the turntable (e.g., 640, FIG. 6F) and (ii) an optical interrupt 714 (e.g., used as a homing switch) to locate the front of the transceiver (e.g., 106, FIG. 1B) relative to an external platform (e.g., Crover 802, FIG. 8B) that the transceiver is coupled to.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop and evaluate an experimental system (also referred to as a biological visual communication system (BVisCom)) comprising . . . , as described in relation to FIGS. 1-4.

### Validation Tests

The study conducted a set of validation tests to investigate the capabilities of communicating different formatted data packets or messages between two experimental systems. The study conducted the tests unidirectionally, where one experimental system encoded messages and transmitted them, while the other received the messages and decoded them.

The study conducted 3 validation tests. The study conducted the first test to establish the display actuation speed, which is the delay between consecutive display states. This delay is a critical performance parameter of the experimental system as it is used to define the transmission throughput. The study conducted the second test to investigate the cyclic redundancy checks (CRC) error detection algorithm and filter out improperly formatted or incomplete messages. The study conducted the last test to investigate the limits of using a backlit display as a visual transmitter (e.g., 102, FIG. 1A).

The study conducted the 3 validation tests by transmitting 10 randomly generated data packets or messages from all formats (e.g., 0-level, low-level, high-level) that were then broadcast by a transmitter (of the experimental system) and received by a receiver (of the experimental system) attached to a laptop. The sequence of transmitted data packets or messages was recorded by the experimental system, and the transmission sequence was compared to the sequence of decoded data packets or messages detected by the receiver. Both the number of detected data packets or messages and the accuracy of the detected data packet or message sequence were used to evaluate the effectiveness of the experimental system.

Validation Test #1. The study conducted the first validation test with (i) an electro-mechanical display (on the transmitter) and (ii) a camera (e.g., Oak-1) attached to a laptop running the detection algorithm (as the receiver). The study started the test with a display delay of 1 second and decreased the delay interval by 0.05 seconds. The study decreased the delay to 0.4 seconds and still had 100% successful detection of the number of data packets or messages and the sequence of the data packets or messages. If the delay dropped lower than 0.4 seconds, the study had a full loss of functionality of the electromechanical display.

The camera operated at a maximum frame rate of 44 frames per second (fps). The study operated the electromechanical display from 1 fps to 2.5 fps with a 0.4-second delay. The study then reviewed specifications of the actuators (e.g., servos) used in the display to identify the actuation speed of the actuators. The no-load actuation speed was specified at 0.12 seconds per 60° of rotation. In the study, for the flapper to rotate 180°, the actuators needed to rotate 120°, so the maximum speed that the flapper could move 180° was 0.36 seconds if the flapper provided no load on the actuator.

The loss of display functionality at 0.4 seconds was caused by the actuation speed of the display's actuators. This delay provided the actuators with sufficient time to complete their motion before receiving subsequent commands. The actuators (e.g., servos) used in the display operated at a fixed speed and could not handle overlapping commands. If a new command was issued before the completion of an ongoing operation, the actuator could prematurely terminate the first operation and attempt to execute the next. The study represented this behavior, where the flappers fully actuated and produced a detectable AprilTag. When the study reran the test with a delay of 0.45 seconds, the experimental system achieved a 100% success rate in producing detectable AprilTags, confirming that the mechanical load associated with flipping the flappers caused operational failures when the actuation delay was between 0.4 and 0.45 seconds. To ensure reliable performance, the study set a standard actuation delay at 0.5 seconds. This provided a safety margin to accommodate potential increases in mechanical load due to wear, debris, or other factors that could affect actuator performance, thereby ensuring complete flapper rotation and consistent AprilTag generation.

Validation Test #2. As discussed above, a 0-level packet structure is broadcast with no expectation of response, whereas a low-level and a high-level packet structure carry an expectation of response. The transmitter could repeat the broadcast if a low-level or high-level packet structure was broadcast and no response was received.

The study conducted the second validation test to investigate and confirm the functionality of 2 error correction methods: (i) repetition filtering and (ii) CRC check. The study wanted to determine if the experimental system could identify a properly formatted low-level or high-level packet structure in case the experimental system also detected the end of a partial message. In this scenario, the experimental system did not detect the entirety of the first data packet or message, so the experimental system did not broadcast a confirming data packet or message. The data packet or message was rebroadcast, but given the configuration of the detection algorithm, there was a risk that the detection queue could contain the ATs from the first data packet or message.

The study conducted the second validation test using the same broadcast algorithm as in the first validation test, but the study modified the broadcast algorithm so that a random AT within the data packet or message was randomly changed. Additionally, with the intentionally erroneous messages determined, the experimental system also appended the back half of the data packet or message to the front of the broadcast to simulate the tail of the first data packet or message that was then rebroadcast. The data packet or messages were broadcast using the same parameters in the first validation test.

The study conducted the second validation test using the same methodology as the first validation test. Ten randomly selected messages were broadcast, and the broadcast sequence was recorded. The detection algorithm then decoded the received data packets or messages and recorded the corresponding sequence. To evaluate the performance of the detection algorithm, the sequence of detected data packets or messages and the number of recorded data packets or messages were compared against the broadcast sequence. Using the message broadcast delay of 0.5 seconds established in the first validation test, the experimental system detected and identified the proper sequence and number of broadcast data packets or messages, achieving a 100% detection rate.

Validation Test #3. After completing the validation tests with the electromechanical display, the study used a back-lit display (e.g., a computer monitor's digital display) to evaluate the experimental system. The study conducted the third validation test to investigate the capabilities of using a computer monitor's digital display as a display for the experimental system. In this validation test, the study wanted to test different things. First, the study investigated whether the computer monitor's digital display could replace the electromechanical display. The study (i) operated the computer monitor's digital display using the same parameters in the first validation test and (ii) compared the detection performance between the electromechanical display and the computer monitor's digital display. Second, the study investigated the interaction between the refresh rate of the computer monitor's digital display and the camera.

The camera operated at 44 fps, and the computer monitor's digital display had a 90 Hz refresh rate. The study followed the same procedure in the first validation test and started with broadcasting a random selection of 10 messages with a display delay of one second. The study then recorded the number of data packets or messages detected and the accuracy of the detected data packets or messages. The study repeated the random packet or message broadcast 10 times before moving to a different display delay. The study started at a message delay of 0.5 seconds and descended to a 0.1-second delay at 0.1-second increments. When the study saw the performance drop-off, the study investigated the step where the drop-off occurred to understand the limits of the experimental system.

Table 4 shows results for the third validation test with a message delay from 0.1 to 0.5 seconds. The number in parentheses represents the number of correct detections resulting from the CRC error correction. The other number indicates the number of correct detections that did not need the CRC algorithm.

TABLE 4

| | | Test runs | | | | |
|---|---|---|---|---|---|---|
| | | 1 | 2 | 3 | 4 | 5 |
| Message | 0.5 | 10 | 10 | 10 | 10 | 10 |
| delay (s) | 0.4 | 10 | 10 | 10 | 10 | 10 |
| | 0.3 | 10 | 10 | 10 | 10 | 10 |
| | 0.2 | 10 | 10 | 10 | 10 | 10 |
| | 0.1 | 2 (1) | 1 | 0 (2) | 3 (2) | 1 (1) |

In Table 1, the experimental system had 100% detection rate down to a 0.2-second delay, but the experimental system had a performance drop from a 0.2-second delay to a 0.1-second delay. During the 0.1-second delay testing, the study had many data packet or message broadcasts where the original data packet or message broadcast was not detected, but the CRC algorithm accurately determined the intended data packet or message.

Additionally, the camera's frame rate consistently remained between 40 and 44 frames per second. However, the camera's frame rate occasionally dropped to, but not lower than, 34 frames per second. The fluctuations in the frame rate could be due to interactions between the camera, the onboard GPU computational load, and the camera management firmware.

Table 5 shows the number of available frames for the camera (e.g., Oak-1) to run detection (via a trained AI model) based on the time delay of the computer monitor's digital display. Although the detection algorithm (e.g., you only look once (YOLO)) could operate on the detection of one frame, the detection performance suffered if the number of detected frames dropped below 8 frames.

TABLE 5

| | | 35 FPS | 44 FPS |
|---|---|---|---|
| Message delay (s) | 0.5 | 17.5 | 22 |
| | 0.4 | 14 | 17.6 |
| | 0.3 | 10.5 | 13.2 |
| | 0.2 | 8 | 8.8 |
| | 0.1 | 3.5 | 4.4 |

The study then investigated the 0.2 and the 0.1 delay timestamps to understand the performance of the detection algorithm between these timestamps. The study started by (i) creating subdivisions between the 0.2 and 0.1 timestamps and (ii) testing a delay of 0.15 seconds. Table 6 shows the results of the third validation test using subdivisions between 0.2 and 0.1 timestamps. As shown, although the results were more favorable than the 0.1-second delay, the detection algorithm's response was unacceptable for the experimental communication system. The study could push the delay lower than 0.2 seconds, but the variability of the detection algorithm's response was not favorable for the detection algorithm. The detection algorithm's best response was at a message delay of 0.2 seconds, with a 2.5 times faster transmission speed than the electromechanical display.

TABLE 6

| | | Test runs | | | | |
|---|---|---|---|---|---|---|
| | | 1 | 2 | 3 | 4 | 5 |
| Message | 0.175 | 9 (1) | 10 | 10 | 10 | 9 (1) |
| delay (s) | 0.15 1 | 0 | 9 | 10 | 5 (2) | 9 |
| | 0.1375 | 9 | 5 | 4 (2) | 8 | 8 (2) |
| | 0.125 | 7 (2) | 6 (1) | 2 (4) | 4 (2) | 5 (2) |

Note:
The number in parentheses represents the number of correct detections resulting from the CRC error correction. The other number indicates the number of correct detections that did not need the CRC algorithm.

FIG. 8A shows a box-and-whisker plot comparing the detection algorithm's performance with and without the CRC check. The plot represents an aggregate of the data from Tables 5 and 6 to show a complete representation of the third validation test. In FIG. 8A, from left to right for each dataset (e.g., no CRC, CRC), the data goes from the 0.5-second time step to a 0.1-second time step.

### Application Test

The study conducted two application tests to assess the experimental system's viability in practical applications. The first application test (also referred to as a passive detection test) used the receiver, but not the transmitter, in the experimental system. In the first application test, the receiver was coupled to Crover (e.g., 802, FIG. 8B) and configured to receive 0-level data packets or messages from static placements (e.g., street signs), and then Crover processed the received data packets or messages, abstracted the received data packets or messages, and internalized how to respond according to the received data packets or messages.

The second application test evaluated the performance of the experimental system when the experimental system engaged in a collaborative operation with another communication system. In the second application test, a collaborator (e.g., another communication system) asked if Crover could help with a collaborative operation, and then Crover responded and assisted as requested, and terminated the collaboration when the task was completed. The second application test required using all types of data packet or message formats (i.e., packet structures) with bidirectional communication between the two parties.

FIG. 8B shows an autonomous vehicle 802, referred to as Crover, coupled to the experimental system 100.

Application Test #1. FIG. 8C shows the layout for the passive signage test (also referred to as the first application test). In the first application test, Crover performed an automated driving task, and the street signage was implemented as AprilTags detected by the experimental system as 0-level messages. The first application test had two goals: (i) to confirm that Crover could execute the abstract commands given by the experimental system, and (ii) to confirm that the experimental system could operate in a reception-only mode using the receiver.

After the automation was initiated for Crover, the study showed ATO to Crover, which the experimental system read as a 0-level message, to indicate that the test area was ready. The experimental system then told Crover to run a self-check and proceed with the automated driving operation. Crover then uses its front camera to follow ArUco tags, which were used to define the driving lane and provide steering feedback. While driving the defined path, the experimental system on Crover read the AT signage and responded accordingly. The study conducted the first application test ten times, and each time, Crover and the experimental system completed all of the required tasks.

Table 7 shows the performance results of the first application test. The data in Table 7 represent the delay between detection and actuation between the experimental system and Crover. The results of the first application test detail the processing time that the automation algorithm needed to process the abstract commands output from the experimental system and then determine the response Crover needed to execute based on these commands.

TABLE 7

| | Mean (s) | Standard deviation (s) |
|---|---|---|
| 0-level 1 | 0.912181 | 0.709780 |
| 0-level 2 | 0.000874 | 0.001413 |
| 0-level 3 | 0.000901 | 0.000605 |
| 0-level 4 | 0.002091 | 0.001537 |
| 0-level 5 | 0.002190 | 0.001665 |

In Table 7, message 1 (shown as 0-level 1) (see Msg 1, FIG. 8C) is the most time-consuming and variable of these commands, because message 1 corresponds to the command Crover needed to initiate its self-driving automation. The response to the receipt of message 1 was the initiation of Crover's kinematics and the entirety of the automation protocol. Messages 2 (shown as 0-level 2) (see Msg 2, FIG. 8C) and message 3 (shown as 0-level 3) (see Msg 3, FIG. 8C) commanded Crover to increase and decrease speed, respectively. The command from messages 2 and 3 only drove a change in the throttle, which was not a resource-intensive command, so the delay for processing messages 2 and 3 was the shortest of the five messages. Message 4 commanded a series of actions that required Crover to maintain its lowered speed whilst turning to the left until Crover saw a “Parking” sign. The command from message 4 required the interaction of numerous automation functions, so the processing delay was higher. Message 5 triggered both steering and throttle feedback to align Crover on the “Parking” sign and stop before the sign. These actions required extensive processing power to execute the steering and throttle feedback, so the system response was the slowest for these actions.

After the first application test, the study concluded that the experimental system could control an automated system (e.g., Crover) in a basic response-only operation (e.g., receiver only). In the first application test, Crover was only required to respond to the commands broadcast by the experimental system and did not need to broadcast confirmations or messages on its end.

Application Test #2. In the second application test, the study configured a computer as a transmitter of a second experimental system. Crover carried the first experimental system, used in previous validation and application tests, with an electromechanical display (e.g., 118, FIGS. 1A-1B). The computer ran on a different operating system from Crover, and the computer and Crover were not networked together. There was zero compatibility between the computer and Crover, other than the communication functionality created by the experimental systems.

On the computer, a communication script was written using the same protocols and logic implemented on Crover and its integrated experimental system. The difference was that the script contained all communication functionality without an exchange pipeline to other sources. The communication script used the same detection pipeline and employed an Oak-1 camera connected via USB, and a person could select and execute data packets or messages for broadcast on the monitor. The study developed the following scenario to test the experimental system in a collaborative operation.

The study wanted to simulate an operation where the person requested Crover to perform some actions. An example application for this scenario would be a person requesting assistance from an automated platform to help transport or deliver an article from one location to another. The study defined a scenario that allowed both parties (e.g., the person and Crover) to require interaction from each other to execute a collaborative operation. As such, the scenario for the second application test was defined by the sequence shown in Table 8.

TABLE 8

| Sequence | Details |
|---|---|
| 1 | Crover, powered and initialized, was sitting idle and awaiting a command. |
| 2 | A person approached Crover and transmitted, via the second experimental system, an |
| | “Are you available to help?” message. This message was formatted as a low-level message |
| | that expected a simple confirmation. |
| | The Crover performed an internal check to determine any queued actions. If idle, Crover |
| | responded, via the first experimental system, with a 0-level “Yes”. If occupied, Crover |
| | responded, via the first experimental system, with a 0-level “No”. |
| 3 | If Crover responded, via the first experimental system, with a “Yes”, then the human |
| | transmitted, via the second experimental system, a “Can you follow me?” message to |
| | Crover, which was formatted as a low-level message that expected a simple confirmation. |
| | Crover performed an internal check to determine if it could perform a Follow action. |
| | Crover checked if the Oak-1 pipeline was established for steering and throttle feedback. |
| | Crover also checked if the steering and throttle interfaces were initialized. If Crover could |
| | perform a Follow action, it responded, via the first experimental system, with a 0-level |
| | “Yes”. If Crover could not perform a Follow action, it responded, via the first experimental |
| | system, with a 0-level “No”. |
| 4 | If Crover responded with a “Yes”, then the person produced an AprilTag sign to use as |
| | an identifier for the follow action. Once the tracking AprilTag was produced, the Crover |
| | initiated the Follow automation and followed the person holding the sign. |
| 5 | While following the person, Crover detected a hazard and paused the Follow action. This |
| | hazard was identified with an ArUco tag. Crover then communicated to the person that |
| | there was a hazard, and Crover could not proceed. The hazard status was communicated |
| | with a 0-level message while the Crover sat idle and awaited aid. |
| 6 | The person, receiving the message broadcast from Crover, sent, via the second experimental |
| | system, a “What is your status?” message to Crover that was formatted as a low-level |
| | message. |
| 7 | Crover responded, via the first experimental system, by clarifying the status of the hazard, |
| | indicating that the status was an obstacle, and requesting help in clearing the obstacle. This |
| | message was broadcast as a high-level message because of the complexity of the request |
| | and the need for a task identifier to assist in processing the message. Crover used a task |
| | identifier that corresponded to an aid request. With this identifier, Crover was awaiting (i) |
| | confirmation that the request had been received and (ii) confirmation that the task had been |
| | completed. |
| 8 | After the person cleared the obstacle, the person, via the second experimental system, |
| | broadcast a 0-level confirmation that the request had been completed. |
| 9 | Crover performed an internal check to confirm that the hazard was cleared. When the check |
| | was completed, Crover communicated, via the first experimental system, to the person that |
| | the Follow task was ready to proceed with a 0-level message. |
| 10 | Crover proceeded with the Follow task once the tracking AprilTag was once again |
| | produced. |
| 11 | While continuing the Follow task, the person broadcast, via the second experimental |
| | system, a low-level request for Crover to increase its spacing. Crover confirmed, via the |
| | first experimental system, the request with a 0-level broadcast and increased its distance |
| | from the person. |
| 12 | While continuing the Follow task, the person broadcast, via the second experimental |
| | system, a low-level request for Crover to decrease its spacing. Crover confirmed, via the |
| | first experimental system, the request with a 0-level broadcast and decreased its distance |
| | from the person. |
| 13 | While continuing the Follow task, the person broadcast, via the second experimental |
| | system, a low-level request for Crover to decrease its spacing. Crover denied, via the first |
| | experimental system, the request with a 0-level broadcast and maintained its distance from |
| | the person. |
| 14 | The person, detecting the “Request Denied” response from Crover, queried, via the second |
| | experimental system, about the denial with a low-level query. |
| 15 | Crover responded, via the first experimental system, that it was unable to follow closer with |
| | a 0-level response. |
| 16 | The person terminated, via the second experimental system, the Follow task with a Lo-level |
| | message. |
| 17 | Crover responded, via the first experimental system, with a 0-level confirmation, stopped |
| | the Follow task, and entered an idle state. |

At the end of the ten iterations of the second application test, the study obtained message processing statistical data from the low-level and high-level messages, as shown in Table 9. The processing time of the low-level and high-level messages was identical, but they took a substantial amount of additional time to process compared to the messages from the first application test. This was due to an additional level of automation utilized during the second application test.

TABLE 9

| | Mean (s) | Standard deviation (s) |
|---|---|---|
| Low-level | 0.03002 | 0.00159 |
| Hi-level | 0.03014 | 0.00167 |

After the first application test, the study concluded that the experimental system could control an automated system (e.g., Crover) in a basic response-only operation (e.g., receiver only).

After the second application test, the study concluded that the experimental system could facilitate continuous two-way communications between two or more communication systems or devices.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

[1] M. Kalaitzakis, B. Cain, S. Carroll, A. Ambrosi, C. Whitehead, and N. Vitzilaios, “Fiducial Markers for Pose Estimation,” J Intell Robot Syst, vol. 101, no. 4, p. 71, April 2021, doi: 10.1007/s10846-020-01307-9.

[2] L. Metcalf and W. Casey, Cybersecurity and Applied Mathematics. Elsevier, 2016. doi: 10.1016/C2015-0-01807-X.

[3] E. Olson, “AprilTag: A robust and flexible visual fiducial system,” in 2011 IEEE International Conference on Robotics and Automation, IEEE, May 2011, pp. 3400-3407. doi: 10.1109/ICRA.2011.5979561.

[4] G. Bradski, “The OpenCV Library,” Dr. Dobb's Journal of Software Tools, 2000.

[5] S. Garrido-Jurado, R. Muñoz-Salinas, F. J. Madrid-Cuevas, and M. J. Marin-Jimenez, “Automatic generation and detection of highly reliable fiducial markers under occlusion,” Pattern Recognit, vol. 47, no. 6, pp. 2280-2292, June 2014, doi: 10.1016/j.patcog.2014.01.005.

[6] H. Kato and M. Billinghurst, “Marker tracking and HMD calibration for a video-based augmented reality conferencing system,” in Proceedings 2nd IEEE and ACM International Workshop on Augmented Reality (IWAR'99), IEEE Comput. Soc, October 1999, pp. 85-94. doi: 10.1109/IWAR.1999.803809.

[7] M. Mehring, P. Parker, D. Woods, and E. Jones, “Reseau Plate.” Accessed: Nov. 6, 2024. [Online]. Available: https://www.nasa.gov/history/alsj/alsj-reseau.html.

[8] M. Kalaitzakis, B. Cain, S. Carroll, A. Ambrosi, C. Whitehead, and N. Vitzilaios, “Fiducial Markers for Pose Estimation,” J Intell Robot Syst, vol. 101, no. 4, p. 71, April 2021, doi: 10.1007/s10846-020-01307-9.

[9] P. R. J. Boniface, “ANALYTICAL TRIANGULATION USING A STEREO-PLOTTER AND RÉSEAU PLATE-HOLDERS,” The Photogrammetric Record, vol. 5, no. 30, pp. 492-497, October 1967, doi: 10.1111/j.1477-9730.1967.tb00900.x.

[10] M. Ng, E. Brown, A. Williams, M. Chao, N. Lawrentschuk, and R. Chee, “Fiducial markers and spacers in prostate radiotherapy: current applications,” BJU Int, vol. 113, no. S2, pp. 13-20, March 2014, doi: 10.1111/bju.12624.

What is claimed:

1. A receiver comprising:
a camera configured to acquire an image of a scene; and
a receiver controller comprising:
a receiver processor; and
a receiver memory having receiver instructions stored thereon, wherein execution of the receiver instructions causes the receiver processor to:
receive an image of the scene;
determine presence of a first fiducial marker in the received image, wherein the first fiducial marker has an encoded data packet, transmitted optically via a transmitter, having a message; and
determine, via a trained artificial intelligence (AI) model, one or more observable marker elements of the first fiducial marker, wherein the one or more observable marker elements are used to determine a packet structure for a reply message or a decoding of the first fiducial marker.

2. The receiver of claim 1, wherein the trained AI model was trained to detect and classify observable marker elements using a set of fiducial markers acquired from a set of images or a training dataset, wherein the AI model was trained using fiducial markers and an associated number of observable marker elements as the training data.

3. The receiver of claim 1, wherein the packet structure is configured to be used in a packet transmitted to a target, wherein the packet structure includes an indicator that the target does not need to respond, wherein the packet structure is mapped to an arrangement of the one or more observable marker elements.

4. The receiver of claim 1, wherein the packet structure is configured to be used in a packet transmitted to a target, wherein the packet structure includes an indicator that the target generates a one-time response, wherein the packet structure is mapped to an arrangement of the one or more observable marker elements.

5. The receiver of claim 1, wherein the packet structure is configured to be used in a packet transmitted to a target, wherein the packet structure includes an indicator that the target initiates a subsequent serial exchange of messages with the receiver, wherein the packet structure is mapped to an arrangement of the one or more observable marker elements.

6. The receiver of claim 1, wherein the first fiducial marker is generated or decoded according to a protocol defined by an adjustable AprilTag.

7. The receiver of claim 1, wherein the first fiducial marker is generated or decoded according to an adjustable protocol selected from or based on the group consisting of a QR code, a Ju marker, a Chroma tag, a Vu mark, a Topo tag, an S tag, and an ArUco tag.

8. The receiver of claim 1, wherein the one or more observable marker elements are subsequently used by a transmitter, the transmitter comprising:
a transmitter controller comprising:
a transmitter processor; and
a transmitter memory having transmitter instructions stored thereon, wherein execution of the transmitter instructions causes the transmitter processor to:
receive the one or more observable marker elements of the first fiducial marker;
determine a packet structure of the encoded data packet using the one or more observable marker elements of the first fiducial marker, wherein the determined packet structure is mapped to the one or more observable marker elements of the first fiducial marker;
determine a second fiducial marker having a second encoded data packet, wherein the second encoded data packet has same packet structure as the determined packet structure and includes the reply message; and
demonstrate the second fiducial marker on a display, wherein the second fiducial marker is subsequently imaged for extracting the second encoded data packet.

9. The receiver of claim 8, wherein the display is an electromechanical display comprising:
a plurality of tiles, each being configured to show an observable marker element of the second fiducial marker; and
one or more actuators operatively coupled to the plurality of tiles, the one or more actuators being configured to flip the plurality of tiles in accordance with an arrangement of the one or more observable marker elements of the second fiducial marker.

10. The receiver of claim 9, wherein each tiles is a flapper or a printed placard.

11. The receiver of claim 8, wherein the display is a digital display having a plurality of pixels, each pixel being configured to show an observable marker element of the second fiducial marker.

12. A transmitter comprising:
a transmitter controller comprising:
a transmitter processor; and
a transmitter memory having transmitter instructions stored thereon, wherein execution of the transmitter instructions causes the transmitter processor to:
receive one or more observable marker elements of a first fiducial marker from an external device or from a camera, wherein the first fiducial marker has an encoded data packet having a message;
determine a packet structure of the encoded data packet using the one or more observable marker elements of the first fiducial marker, wherein the determined packet structure is mapped to the one or more observable marker elements of the first fiducial marker;
determine a second fiducial marker having a second encoded data packet, wherein the second encoded data packet has same packet structure as the determined packet structure and includes a reply message; and
demonstrate the second fiducial marker on a display, wherein the second fiducial marker is subsequently imaged for extracting the second encoded data packet.

13. The transmitter of claim 10, wherein the display is an electromechanical display comprising:
a plurality of tiles, each being configured to show an observable marker element of the second fiducial marker; and
one or more actuators operatively coupled to the plurality of tiles, the one or more actuators being configured to flip the plurality of tiles in accordance with an arrangement of the one or more observable marker elements of the second fiducial marker.

14. The transmitter of claim 13, wherein each tile is a flapper or a printed placard.

15. The receiver of claim 12, wherein the display is a digital display having a plurality of pixels, each pixel being configured to show an observable marker element of the second fiducial marker.

16. A non-transitory computer-readable medium having instructions stored thereon, wherein execution of the instructions causes a receiver processor to:
receive an image of a scene acquired by a camera;
determine presence of a first fiducial marker in the received image, wherein the first fiducial marker has an encoded data packet, transmitted optically via a transmitter, having a message; and
determine, via a trained artificial intelligence (AI) model, one or more observable marker elements of the first fiducial marker, wherein the one or more observable marker elements are used to determine a packet structure for a reply message or a decoding of the first fiducial marker.

17. The non-transitory computer-readable medium of claim 16, wherein the trained AI model was trained to detect and classify observable marker elements using a set of fiducial markers acquired from a set of images or a training dataset, wherein the AI model was trained using fiducial markers and an associated number of observable marker elements as the training data.

18. The non-transitory computer-readable medium of claim 16, wherein the first fiducial marker is generated or decoded according to a protocol defined by an adjustable AprilTag.

19. The non-transitory computer-readable medium of claim 16, wherein the execution of the instructions further causes a transmitter processor to:
receive the one or more observable marker elements of the first fiducial marker;
determine a packet structure of the encoded data packet using the one or more observable marker elements of the first fiducial marker, wherein the determined packet structure is mapped to the one or more observable marker elements of the first fiducial marker;
determine a second fiducial marker having a second encoded data packet, wherein the second encoded data packet has same packet structure as the determined packet structure and includes the reply message; and
demonstrate the second fiducial marker on a display, wherein the second fiducial marker is subsequently imaged for extracting the second encoded data packet

20. The non-transitory computer-readable medium of claim 19, wherein the display is an electromechanical display comprising:
a plurality of tiles, each being configured to show an observable marker element of the second fiducial marker; and
one or more actuators operatively coupled to the plurality of tiles, the one or more actuators being configured to flip the plurality of tiles in accordance with an arrangement of the one or more observable marker elements of the second fiducial marker.
